(19) United States
(12) Patent Application Publication
(10) Pub. No.: US 2023/0101937 A1
(43) Pub. Date: Mar. 30, 2023

(54) REBAUDIOSIDE M SWEETENER COMPOSITIONS

(71) Applicant: AMYRIS, INC., Emeryville, CA (US)

(72) Inventors: Stanley W. Herrmann, Emeryville, CA (US); Binita Bhattacharjee, Emeryville, CA (US); Rhodri Jenkins, Emeryville, CA (US); Brian Yip, Emeryville, CA (US); Alex Woo, Emeryville, CA (US)

(21) Appl. No.: 17/906,103

(22) PCT Filed: Mar. 12, 2021
(86) PCT No.: PCT/US21/22055

§ 371 Date: Sep. 12, 2022

Related U.S. Application Data
(60) Provisional application No. 62/989,034, filed on Mar. 13, 2020.

(51) Int. Cl. A23L 27/30; A23L 29/269; A23L 29/30

(52) U.S. Cl. CPC A23L 27/36; A23L 29/273; A23L 29/37

(57) ABSTRACT

Provided herein are high potency sweeteners containing at least 95% rebaudioside M generated from Saccharomyces cerevisiae strains engineered to produce high purity rebaudioside M when fermented with sugar cane syrup. In addition, provided are methods of purifying the high potency sweeteners from cleared fermentation broths. Also provided are sugar substitutes containing the high potency sweeteners and methods of making same.

### FIELD OF THE INVENTION

The present disclosure relates to sweetener compositions containing high purity rebaudioside M and methods of making the sweetener compositions.

### BACKGROUND

Reduced-calorie sweeteners derived from natural sources are desired to limit the health effects of high-sugar consumption. The stevia plant (Stevia rebaudiana Bertoni) produces a variety of sweet-tasting glycosylated diterpenes termed steviol glycosides. Of all the known steviol glycosides, rebaudioside M has the highest potency (˜300 times sweeter than sucrose) and has the most appealing flavor profile. However, rebaudioside M is only produced in minute quantities by the stevia plant and is a small fraction of the total steviol glycoside content (<1.0%), making the isolation of rebaudioside M from stevia leaves impractical. Alternative methods of obtaining rebaudioside M are needed. One such approach is the application of synthetic biology to design microorganisms (e.g. yeast) that produce large quantities of rebaudioside M from sustainable feedstock sources. In addition, given the high-intensity sweetness of rebaudioside M, usable sweeteners like table-top sweeteners and sugar substitutes containing rebaudioside M are needed that dilute the high-intensity sweetness without introducing off flavors are needed.

### SUMMARY OF THE INVENTION

Provided herein are high-intensity sweeteners that contain greater than 95% Rebaudioside M, methods of producing the high-intensity sweeteners, and sugar substitutes containing the high-intensity sweetener and one or more bulking agents.

In one aspect, the invention provides a purified high-intensity sweetener containing at least 95% by weight Rebaudioside M and less than 5000 ppm Rebaudioside D, less than 4000 ppm Rebaudioside B, and less than 2000 ppm Rebaudioside A.

In an embodiment the Rebaudioside D is less than 3200 ppm, the Rebaudioside B is less than 2000 ppm, and the Rebaudioside A is less than 1000 ppm. In another embodiment the Rebaudioside D, Rebaudioside B, and Rebaudioside A are below the limit of quantification (LOQ) when also quantifying Rebaudioside M. In a further embodiment Rebaudioside M, Rebaudioside D, Rebaudioside B, and Rebaudioside A amounts are measured using high performance liquid chromatography (HPLC).

In another aspect, the invention provides a table-top sweetener containing the purified high-intensity sweetener provided herein. In an embodiment the table-top sweetener contains a bulking agent. In another embodiment the bulking agent is selected from erythritol, dextrin, inulin, polydextrose, and maltodextrin.

In another aspect, the invention provides a sugar substitute containing the purified high-intensity sweetener described herein. In an embodiment the sugar substitute contains one or more bulking agents. In another embodiment the bulking agents are selected from erythritol, soluble fiber, dextrin, inulin, polydextrose, and maltodextrin. In yet another embodiment the sugar substitute has the same level of sweetness on a per weight basis as sucrose. In an embodiment the sugar substitute contains from about 85% to about 90% erythritol by weight, from about 9% to about 15% soluble fiber by weight, and from about 0.1% to about 1.0% of the purified high-intensity sweetener described herein. In another embodiment the sugar substitute contains about 90% erythritol by weight, about 9.5% soluble fiber by weight, and about 0.5% of the purified high-intensity sweetener described herein. In another embodiment the soluble fiber is selected from beta-glucans, glucomannan, pectin, gum guar, inulin, fructo-oligosaccharide, digestion resistant dextrin, and polydextrose. In a preferred embodiment the digestion resistant dextrin is NUTRIOSE FM10. In additional embodiments the high-intensity sweetener is agglomerated with the one or more bulking agents.

In yet another aspect, the invention provides a method of preparing the purified high-intensity sweetener involving the steps of obtaining a cleared fermentation broth comprising rebaudioside M; filtering the cleared fermentation broth with an ultrafilter to generate a ultrafiltration permeate; filtering the ultrafiltration permeate with a nanofilter to generate a nanofiltration flow-through; washing the nanofiltration flow-through; and spray drying the washed nanofiltration flow-through to obtain the purified high-intensity sweetener described herein. In an embodiment the ultrafilter has an ultrafiltration cutoff from about 2 kDa to about 100 kDa. In another embodiment the ultrafilter has an ultrafiltration cutoff of about 20 kDa. In yet another embodiment the nanofilter has a nanofiltration cutoff from about 200 Da to about 1000 Da. In a further embodiment the nanofilter has a nanofiltration cutoff of about 300 Da to about 500 Da. In additional embodiments the cleared fermentation broth is pH adjusted to have a pH greater than pH7. In another embodiment the cleared fermentation broth has a pH of about pH10. In further embodiments the nanofiltration flow-through is washed after being acidified with an acid solution. In an embodiment the acid solution comprises citric acid.

In a further aspect, the invention provides a method of making the sugar substitute involving the steps of adding a first bulking agent to a mixer; precoating the mixer with the first bulking agent; adding a second bulking agent, and the purified high-intensity sweetener described herein; mixing the first bulking agent, second bulking agent, and high potency sweetener; adding water to the mix; mixing the first bulking agent, second bulking agent, high potency sweetener, and water; and drying the mixture. In an embodiment, the first bulking agent is erythritol. In another embodiment the second bulking agent is a soluble fiber. In a further embodiment the soluble fiber is digestion resistant dextrin. In yet another embodiment the digestion resistant dextrin is NUTRIOSE FM10.

### BRIEF DESCRIPTION OF THE FIGURES

FIG. 1 is a diagram showing the biochemical pathway from the precursor farnesyl pyrophosphate (FPP) to steviol.

FIG. 2 is a diagram showing the biochemical pathway from the precursor isoprenoid backbone steviol to many of the known steviol glycosides including rebaudioside M.

FIG. 3 is a diagram showing the scale-up of the fermentation process for the production of rebaudioside M.

FIG. 4 is a flow diagram of the purification process used to produce the high-intensity sweetener comprising rebaudioside M.

### DETAILED DESCRIPTION OF THE EMBODIMENTS

As used herein “high-intensity sweetener” refers to sucrose alternatives that are at least several times sweeter than sucrose on a per weight basis. In addition, high-intensity sweeteners are low or zero calorie and do not impact blood sugar levels. Illustrative examples of a high-intensity sweeteners includes the steviol glycosides produced by the plant Stevia rebaudiana. A preferred high-intensity sweetener is one predominantly comprising the steviol glycoside Rebaudioside M.

As used herein “sugar substitute” refers to a food additive that provides a sweet taste like that of sucrose yet contains significantly fewer calories on a per weight basis than sucrose.

As used herein “table-top sweetener” refers to a composition comprising a high-intensity sweetener which is formulated for use by consumers to directly sweeten beverages and food products.

As used herein “bulking agent” refers to any compound that is added to a sweetener formulation in combination with a high-intensity sweetener to provide additional volume or mass to the sweetener formulation. The primary function of the bulking agent is to dilute the high-intensity sweetener to give the sweetener formulation a similar sweetness per volume as sucrose. Any of a number of bulking agents may be used in combination with the high-intensity sweetener. In a preferred embodiment, a polyol, or sugar alcohol, such as erythritol is used as a bulking agent with the acesulfame potassium. Erythritol is preferred because it has a very low caloric content. Also, erythritol is rapidly absorbed in the lower intestine, so it has high digestive tolerance. In addition, since erythritol is a sugar alcohol that does not affect blood serum glucose or insulin levels, it is safe for people with diabetes.

Additional potential bulking agents include, a mixture of two (2) disaccharide alcohols is used. The disaccharide alcohols are gluco-mannitol and gluco-sorbitol. Preferably, the disaccharide alcohols to be used are easily available and low in caloric value. Furthermore, it is preferred that the disaccharide alcohols are non-cariogenic and low glycemic so that the sweetener is less likely to cause tooth decay and to affect blood glucose levels. Also, it is preferred that the bulking agent is white, crystalline and odorless, so that the resulting sweetener provides as realistic a sugar substitute as possible.

As used herein “soluble fiber” and “soluble corn fiber” and “soluble wheat fiber” and “digestion resistant dextrin” refer to bulking agents that are resistant to digestion in the small intestine and that when added as a component of a sugar substitute make the sugar substitute behave like sugar in particular culinary uses, for example in baking. Illustrative soluble fibers include beta-glucans, glucomannan, pectins, gum guar, inulin, fructo-oligosaccharides, digestion resistant dextrins, and polydextrose. A preferred soluble fiber is the digestion resistant dextrin (NUTRIOSE FM10 (Roquette)) a glucose polymer that differs from starch in having (1,2)- and (1,3)-glycosidic linkages in addition to (1,4)- and (1,6)-glycosidic linkages

As used herein, the term “medium” refers to culture medium and/or fermentation medium.

As used herein, the term “production” generally refers to an amount of steviol glycoside produced by a genetically modified host cell provided herein. In some embodiments, production is expressed as a yield of steviol glycoside by the host cell. In other embodiments, production is expressed as the productivity of the host cell in producing the steviol glycoside.

As used herein, the term “kaurenoic acid” refers to the compound kaurenoic acid, including any stereoisomer of kaurenoic acid. In preferred embodiments, the term refers to the enantiomer known in the art as ent-kaurenoic acid and having the following structure:

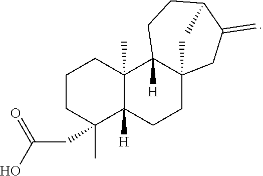

As used herein, the term “steviol” refers to the compound steviol, including any stereoisomer of steviol. In preferred embodiments, the term refers to the compound having the following structure:

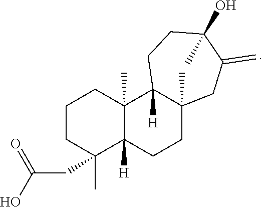

As used herein, the term “steviol glycoside” refers to a glycoside of steviol including but not limited to 19-glycoside, steviolmonoside, steviolbioside, rubusoside, dulcoside B, dulcoside A, rebaudioside A, rebaudioside B, rebaudioside C, rebaudioside D, rebaudioside E, rebaudioside F, rebaudioside G, rebaudioside H, rebaudioside I, rebaudioside J, rebaudioside K, rebaudioside L, rebaudioside M, rebaudioside N, rebaudioside O, rebaudioside D2, and rebaudioside M2.

As used herein, the term “rebaudioside M” or “Reb M” refers to a steviol glycoside having the following structure:

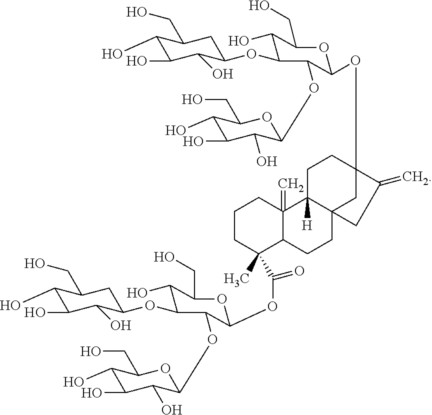

The high-intensity sweetener is produced by fermentation of a host cell engineered to express steviol glycosides. The host cells of the invention have been engineered to express the enzymatic pathway necessary to convert the carbon provided by sugar cane syrup to rebaudioside M. Useful enzymes and nucleic acids encoding the enzymes are known to those of skill in the art. Particularly useful enzymes and nucleic acids are described in the sections below and further described, for example in US2014/0329281 A1, US2014/0357588 A1, US2015/0159188, WO2016/038095 A2, and US2016/0198748 A1.

In further embodiments, the host cells further comprise one or more enzymes capable of making geranylgeranyl diphosphate from a carbon source. These include enzymes of the DXP pathway and enzymes of the MEV pathway. Useful enzymes and nucleic acids encoding the enzymes are known to those of skill in the art. Exemplary enzymes of each pathway are described below and further described, for example, in US2016/0177341 A1 which is incorporated by reference herein in its entirety.

In some embodiments, the host cells comprise one or more or all of the isoprenoid pathway enzymes selected from the group consisting of: (a) an enzyme that condenses two molecules of acetyl-coenzyme A to form acetoacetyl-CoA (e.g., an acetyl-coA thiolase); (b) an enzyme that condenses acetoacetyl-CoA with another molecule of acetyl-CoA to form 3-hydroxy-3-methylglutaryl-CoA (HMG-CoA) (e.g., an HMG-CoA synthase); (c) an enzyme that converts HMG-CoA into mevalonate (e.g., an HMG-CoA reductase); (d) an enzyme that converts mevalonate into mevalonate 5-phosphate (e.g., a mevalonate kinase); (e) an enzyme that converts mevalonate 5-phosphate into mevalonate 5-pyrophosphate (e.g., a phosphomevalonate kinase); (f) an enzyme that converts mevalonate 5-pyrophosphate into isopentenyl diphosphate (IPP) (e.g., a mevalonate pyrophosphate decarboxylase); (g) an enzyme that converts IPP into dimethylallyl pyrophosphate (DMAPP) (e.g., an IPP isomerase); (h) a polyprenyl synthase that can condense IPP and/or DMAPP molecules to form polyprenyl compounds containing more than five carbons; (i) an enzyme that condenses IPP with DMAPP to form geranyl pyrophosphate (GPP) (e.g., a GPP synthase); (j) an enzyme that condenses two molecules of IPP with one molecule of DMAPP (e.g., an FPP synthase); (k) an enzyme that condenses IPP with GPP to form farnesyl pyrophosphate (FPP) (e.g., an FPP synthase); (1) an enzyme that condenses IPP and DMAPP to form geranylgeranyl pyrophosphate (GGPP); and (m) an enzyme that condenses IPP and FPP to form GGPP.

In certain embodiments, the additional enzymes are native. In advantageous embodiments, the additional enzymes are heterologous. In certain embodiments, two or more enzymes may be combined in one polypeptide.

### Cell Strains

Host cells of the invention provided herein include archae, prokaryotic, and eukaryotic cells.

Suitable prokaryotic host cells include, but are not limited to, any of a gram-positive, gran-negative, and gram-variable bacteria. Examples include, but are not limited to, cells belonging to the genera: Agrobacterium, Alicyclobacillus, Anabaena, Anacystis, Arhrobacter, Azobacter, Bacillus, Brevibacterium, Chromatium, Clostridium, Corynebacterium, Enterobacter, Erwinia, Escherichia, Lactobacillus, Lactococcus, Mesorhizobium, Methylobacterium, Microbacterium, Phormidium, Pseudomonas, Rhodobacter, Rhodopseudomonas, Rhodospirillum, Rhodococcus, Salmonella, Scenedesmun, Serratia, Shigella, Staphylococcus, Strepromyces, Synnecoccus, and Zymomonas. Examples of prokaryotic strains include, but are not limited to: Bacillus subtilis, Bacillus amyloliquefacines, Brevibacterium ammoniagenes, Brevibacterium immariophilum, Clostridium beigerinckii, Enterobacter sakazakii, Escherichia coli, Lactococcus lactis, Mesorhizobium loti, Pseudomonas aeruginosa, Pseudomonas mevalonii, Pseudomonas pudica, Rhodobacter capsulatus, Rhodobacter sphaeroides, Rhodospirillum rubrum, Salmonella enterica, Salmonella typhi, Salmonella typhimurium, Shigella dysenteriae, Shigella flexneri, Shigella sonnei, and Staphylococcus aureus. In a particular embodiment, the host cell is an Escherichia coli cell.

Suitable archae hosts include, but are not limited to, cells belonging to the genera: Aeropyrum, Archaeglobus, Halobacterium, Methanococcus, Methanobacterium, Pyrococcus, Sulfolobus, and Thermoplasma. Examples of archae strains include, but are not limited to: Archaeoglobus fulgidus, Halobacterium sp., Methanococcus jannaschii, Methanobacterium thermoautotrophicum, Thermoplasma acidophilum, Thermoplasma volcanium, Pyrococcus horikoshii, Pyrococcus abyssi, and Aeropyrum pernix.

Suitable eukaryotic hosts include, but are not limited to, fungal cells, algal cells, insect cells, and plant cells. In some embodiments, yeasts useful in the present methods include yeasts that have been deposited with microorganism depositories (e.g. IFO, ATCC, etc.) and belong to the genera Aciculoconidium, Ambrosiozyma, Arthroascus, Arxiozyma, Ashbya, Babjevia, Bensingtonia, Botryoascus, Botryozyma, Brettanomyces, Bullera, Bulleromyces, Candida, Citeromyces, Clavispora, Cryptococcus, Cystofilobasidium, Debaryomyces, Dekkara, Dipodascopsis, Dipodascus, Eeniella, Endomycopsella, Eremascus, Eremothecium, Erythrobasidium, Fellomyces, Filobasidium, Galactomyces, Geotrichum, Guilliermondella, Hanseniaspora, Hansenula, Hasegawaea, Holtermannia, Hormoascus, Hyphopichia, Issatchenkia, Kloeckera, Kloeckeraspora, Kluyveromyces, Kondoa, Kuraishia, Kurtzmanomyces, Leucosporidium, Lipomyces, Lodderomyces, Malasserzia, Metschnikowia, Mrakia, Myxozyma, Nadsonia, Nakazawaea, Nematospora, Ogataea, Oosporidium, Pachysolen, Phachytichospora, Phaffia, Pichia, Rhodosporidium, Rhodotorula, Saccharomyces, Saccharomycodes, Saccharomycopsis, Saitoella, Sakaguchia, Saturnospora, Schizoblastoporion, Schizosaccharomyces, Schwanniomyces, Sporidiobolus, Sporobolomyces, Sporopachydermia, Stephanoascus, Sterigmatomyces, Sterigmatosporidium, Symbiotaphrina, Sympodiomyces, Sympodiomycopsis, Torulaspora, Trichosporiella, Trichosporon, Trigonopsis, Tsuchiyaea, Udeniomyces, Waltomyces, Wickerhamia, Wickerhamiella, Williopsis, Yamadazyma, Yarrowia, Zygoascus, Zygosaccharomyces, Zygowilliopsis, and Zygozyma.

In some embodiments, the host microbe is Saccharomyces cerevisiae, Pichia pastoris, Schizosaccharomyces pombe, Dekkera bruxellensis, Kluyveromyces lactis (previously called Saccharomyces lactis), Kluveromyces marxianus, Arxula adeninivorans, or Hansenula polymorpha (now known as Pichia angusta). In some embodiments, the host microbe is a strain of the genus Candida, such as Candida lipolytica, Candida guilliermondii, Candida krusei, Candida pseudotropicalis, or Candida utils.

In preferred embodiments, the host microbe is Saccharomyces cerevisiae. In some embodiments, the host is a strain of Saccharomyces cerevisiae selected from Baker's yeast, CEN.PK2, CBS 7959, CBS 7960, CBS 7961, CBS 7962, CBS 7963, CBS 7964, IZ-1904, TA, BG-1, CR-1, SA-1, M-26, Y-904, PE-2, PE-5, VR-1 BR-1, BR-2, ME-2, VR-2, MA-3, MA-4, CAT-1, CB-1, NR-1, BT-1, and AL-1. In some embodiments, the host microbe is a strain of Saccharomyces cerevisiae selected from PE-2, CAT-1, VR-1, BG-1, CR-1, and SA-1. In a particular embodiment, the strain of Saccharomyces cerevisiae is PE-2. In another particular embodiment, the strain of Saccharomyces cerevisiae is CAT-1. In another particular embodiment, the strain of Saccharomyces cerevisiae is BG-1.

### The Steviol Glycoside Biosynthesis Pathway

In some embodiments, rebaudioside M biosynthesis pathway is activated in the genetically modified host cells by engineering the cells to express polynucleotides encoding enzymes capable of catalyzing the biosynthesis of steviol glycosides.

In some embodiments, the genetically modified host cells contain a heterologous polynucleotide encoding geranylgeranyl diphosphate synthase (GGPPS), a heterologous polynucleotide encoding copalyl diphosphate synthase (CDPS), a heterologous polynucleotide encoding kaurene synthase (KS), a heterologous polynucleotide encoding kaurene oxidase (KO), a heterologous polynucleotide encoding kaurene acid hydroxylase (KAH), a heterologous polynucleotide encoding cytochrome P450 reductase (CPR), a heterologous polynucleotide encoding a UDP-glucose transferase, a heterologous polynucleotide encoding UGT74G1, a heterologous polynucleotide encoding UGT76G1, a heterologous polynucleotide encoding UGT85C2, a heterologous polynucleotide encoding UGT91D, a heterologous polynucleotide encoding EUGT11, or a heterologous polynucleotide encoding UGT40087. In some embodiments, the genetically modified host cells contain a heterologous polynucleotide encoding a variant GGPPS, CDPS, KS, KO, KAH, CPR, UDP-glucose transferase, UGT74G1, UGT76G1, UGT85C2, UGT91D, EUGT11, or UGT40087. In certain embodiments, the variant enzyme may have from 1 up to 20 amino acid substitutions relative to a reference enzyme. In certain embodiments, the coding sequence of the polynucleotide is codon optimized for the particular host cell.

### Geranylgeranyl Diphosphate Synthase (GGPPS)

Geranylgeranyl diphosphate synthases (EC 2.5.1.29) catalyze the conversion of farnesyl pyrophosphate into geranylgeranyl diphosphate. Examples of geranylgeranyl diphosphate synthase include those of Stevia rebaudiana (accession no. ABD92926), Gibberella fujikuroi (accession no. CAA75568), Mus musculus (accession no. AAH69913), Thalassiosira pseudonana (accession no. XP_002288339), Streptomyces clavuligerus (accession no. ZP-05004570), Sulfulobus acidocaldarius (accession no. BAA43200), Synechococcus sp. (accession no. ABC98596), Arabidopsis thaliana (accession no. MP_195399), and Blakeslea trispora (accession no. AFC92798.1), and those described in US2014/0329281 A1.

### Copalyl Diphosphate Synthase (CDPS)

Copalyl diphosphate synthases (EC 5.5.1.13) catalyze the conversion of geranylgeranyl diphosphate into copalyl diphosphate. Examples of copalyl diphosphate synthases include those from Stevia rebaudiana (accession no. AAB87091), Streptomyces clavuligerus (accession no. EDY51667), Bradyrhizobioum japonicum (accession no. AAC28895.1), Zea mays (accession no. AY562490), Arabidopsis thaliana (accession no. NM_116512), and Oryza sativa (accession no. Q5MQ85.1), and those described in US2014/0329281 A1.

### Kaurene Synthase (KS)

Kaurene synthases (EC 4.2.3.19) catalyze the conversion of copalyl diphosphate into kaurene and diphosphate. Examples of enzymes include those of Bradyrhizobium japonicum (accession no. AAC28895.1), Arabidopsis thaliana (accession no. Q9SAK2), and Picea glauca (accession no. ADB55711.1), and those described in US2014/0329281 A1.

### Bifunctional Copalyl Diphosphate Synthase (CDPS) and Kaurene Synthase (KS)

CDPS-KS bifunctional enzymes (EC 5.5.1.13 and EC 4.2.3.19) may also be used in the host cells of the invention. Examples include those of Phomopsis amygdali (accession no. BAG30962), Phaeosphaeria sp. (accession no. 013284), Physcomitrella patens (accession no. BAF61135), and Gibberella fujikuroi (accession no. Q9UVY5.1), and those described in US2014/032928 A1, US2014/0357588 A1, US2015/0159188, and WO2016/038095.

### Ent-Kaurene Oxidase (KO)

Ent-kaurene oxidases (EC 1.14.13.88) also referred to as kaurene oxidases herein catalyze the conversion of kaurene into kaurenoic acid. Illustrative examples of enzymes include those of Oryza sativa (accession no. Q5Z5R4), Gibberella fujikuroi (accession no. 094142), Arabidopsis thaliana (accession no. Q93ZB2), Stevia rebaudiana (accession no. AAQ63464.1), and Pisum sativum (Uniprot no. Q6XAF4), and those described in US2014/0329281 A1, US2014/0357588 A1, US2015/0159188, and WO2016/038095.

### Kaurenoic Acid Hydroxylase (KAH)

Kaurenoic acid hydroxylases (EC 1.14.13) also referred to as steviol synthases catalyze the conversion of kaurenoic acid into steviol. Examples of enzymes include those of Stevia rebaudiana (accession no. ACD93722), Arabidopsis thaliana (accession no. NP_197872), Vitis vinifera (accession no. XP_002282091), and Medicago trunculata (accession no. ABC59076), and those described in US2014/0329281, US2014/0357588, US2015/0159188, and WO2016/038095.

### Cytochrome P450 Reductase (CPR)

Cytochrome P450 reductases (EC 1.6.2.4) are necessary for the activity of KO and/or KAH above. Examples of enzymes include those of Stevia rebaudiana (accession no. ABB88839), Arabidopsis thaliana (accession no. NP_194183), Gibberella fujikuroi (accession no. CAE09055), and Artemisia annua (accession no. ABC47946.1), and those described in US2014/0329281, US2014/0357588, US2015/0159188, and WO2016/038095.

### UDP Glycosyltransferase 74G1 (UGT74G1)

UGT74G1 is capable of functioning as a uridine 5′-diphospho glucosyl:steviol 19-COOH transferase and as a uridine 5′-diphospho glucosyl:steviol-13-O-glucoside 19-COOH transferase. Accordingly, UGT74G1 is capable of converting steviol to 19-glycoside; converting steviol to 19-glycoside, steviolmonoside to rubusoside; and steviolbioside to stevioside. UGT74G1 has been described in Richman et al., 2005, Plant J., vol. 41, pp. 56-67; US2014/0329281; WO2016/038095; and accession no. AAR06920.1.

### UDP Glycosyltransferase 76G1 (UGT76G1)

UGT76G1 is capable of transferring a glucose moiety to the C-3′ position of a acceptor molecule a steviol glycoside (where glycoside=Glcb(1->2)G1c). This chemistry can occur at either the C-13-O-linked glucose of the acceptor molecule, or the C-19-O-linked glucose acceptor molecule. Accordingly, UGT76G1 is capable of functioning as a uridine 5′-diphospho glucosyltransferase to the: (1)C-3′ position of the 13-O-linked glucose on steviolbioside in a beta linkage forming Reb B, (2)C-3′ position of the 19-O-linked glucose on stevioside in a beta linkage forming Reb A, and (3)C-3′ position of the 19-O-linked glucose on Reb D in a beta linkage forming Reb M. UGT76G1 has been described in Richman et al., 2005, Plant J., vol. 41, pp. 56-67; US2014/0329281; WO2016/038095; and accession no. AAR06912.1.

### UDP Glycosyltransferase 85C2 (UGT85C2)

UGT85C2 is capable of functioning as a uridine 5′-diphospho glucosyl:steviol 13-OH transferase, and a uridine 5′-diphospho glucosyl:steviol-19-O-glucoside 13-OH transferase. UGT85C2 is capable of converting steviol to steviolmonoside and is also capable of converting 19-glycoside to rubusoside. Examples of UGT85C2 enzymes include those of Stevia rebaudiana: see e.g., Richman et al., (2005), Plant J., vol. 41, pp. 56-67; US2014/0329281; WO2016/038095; and accession no. AAR06916.1.

### UDP Glycosyltransferase 91D (UGT91D)

UGT91D is capable of functioning as a uridine 5′-diphosphoglucosyl:steviol-13-O-glucoside transferase, transferring a glucose moiety to the C-2′ of the 13-O-glucose of the acceptor molecule, steviol-13-O-glucoside (steviolmonoside) to produce steviolbioside. A UGT91D is also capable of functioning as a uridine 5′-diphosphoglucosyl:rubusoside transferase, transferring a glucose moiety to the C-2′ of the 13-O-glucose of the acceptor molecule, rubusoside, to provide stevioside. UGT91D is also referred to as UGT91D2, UGT91D2e, or UGT91D-like3. Examples of UGT91D enzymes include those of Stevia rebaudiana: see e.g., accession no. ACE87855.1; US2014/0329281; and WO2016/038095.

### UDP Glycosyltransferase 40087 (UGT40087)

UGT40087 is capable of transferring a glucose moiety to the C-2′ position of the 19 glucose of Reb A to produce Reb D. UGT40087 is also capable of transferring a glucose moiety to the C-2′ position of the 19-O-glucose of stevioside to produce Reb E. Examples of UGT40087 include those of accession no. XP_004982059.1 and WO2018/031955.

### Additional Uridine Diphosphate-Dependent Glycosyl Transferases Capable of Converting Reb A to Reb D (UGTAD)

In addition to UGT40087, other UGTAD are capable of transferring a glucose moiety to the C-2′ position of 19-O-glucose of Reb A to produce Reb D. UGTAD is also capable of transferring a glucose moiety to the C-2′ position of 19-O-glucose of stevioside to produce Reb E. Examples of UGTAD include Os_UGT_91C1 from Oryza sativa (also referred to as EUGT11 (see WO2013/022989 and accession number XP_01529141.1)); S1_UGT_101249881 from Solanum lycopersicum (also referred to as UGTSL2 (see WO2014/193888 and accession no. XP_0042504851)); sr.UGT_925778; Bd_UGT0840 (see accession no. XP_003560669.1); Hv_UGT_V1 (see accession no. BAJ94055.1); Bd_UGT10850 (see accession no. XP_010230871.1); and OB_UGT91B1_like (see accession no. XP_0066504551.).

MEV Pathway FPP and/or GGPP Production

In some embodiments, a genetically modified host cell provided herein comprises one or more heterologous enzymes of the MEV pathway, useful for the formation of FPP and/or GGPP. The one or more enzymes of the MEV pathway may include an enzyme that condenses acetyl-CoA with malonyl-CoA to form acetoacetyl-CoA; an enzyme that condenses two molecules of acetyl-CoA to form acetoacetyl-CoA; an enzyme that condenses acetoacetyl-CoA with acetyl-CoA to form HMG-CoA; or an enzyme that converts HMG-CoA to mevalonate. In addition, the genetically modified host cells may include a MEV pathway enzyme that phosphorylates mevalonate to mevalonate 5-phosphate; a MEV pathway enzyme that converts mevalonate 5-phosphate to mevalonate 5-pyrophosphate; a MEV pathway enzyme that converts mevalonate 5-pyrophosphate to isopentenyl pyrophosphate; or a MEV pathway enzyme that converts isopentenyl pyrophosphate to dimethylallyl diphosphate. In particular, the one or more enzymes of the MEV pathway are selected from acetyl-CoA thiolase, acetoacetyl-CoA synthetase, HMG-CoA synthase, HMG-CoA reductase, mevalonate kinase, phosphomevalonate kinase, mevalonate pyrophosphate decarboxylase, and isopentyl diphosphate:dimethylallyl diphosphate isomerase (IDI or IPP isomerase). The genetically modified host cell of the invention may express one or more of the heterologous enzymes of the MEV from one or more heterologous nucleotide sequences comprising the coding sequence of the one or more MEV pathway enzymes.

In some embodiments, the genetically modified host cell comprises a heterologous nucleic acid encoding an enzyme that can convert isopentenyl pyrophosphate (IPP) into dimethylallyl pyrophosphate (DMAPP). In addition, the host cell may contain a heterologous nucleic acid encoding an enzyme that may condense IPP and/or DMAPP molecules to form a polyprenyl compound. In some embodiments, the genetically modified host cell further contains a heterologous nucleic acid encoding an enzyme that may modify IPP or a polyprenyl to form an isoprenoid compound such as FPP.

### Conversion of Acetyl-CoA to Acetoacetyl-CoA

The genetically modified host cell may contain a heterologous nucleic acid that encodes an enzyme that may condense two molecules of acetyl-coenzyme A to form acetoacetyl-CoA (an acetyl-CoA thiolase). Examples of nucleotide sequences encoding acetyl-CoA thiolase include (accession no. NC_000913 REGION: 2324131.2325315 (Escherichia coli)); (D49362 (Paracoccus denitrificans)); and (L20428 (Saccharomyces cerevisiae)).

Acetyl-CoA thiolase catalyzes the reversible condensation of two molecules of acetyl-CoA to yield acetoacetyl-CoA, but this reaction is thermodynamically unfavorable; acetoacetyl-CoA thiolysis is favored over acetoacetyl-CoA synthesis. Acetoacetyl-CoA synthase (AACS) (also referred to as acetyl-CoA:malonyl-CoA acyltransferase; EC 2.3.1.194) condenses acetyl-CoA with malonyl-CoA to form acetoacetyl-CoA. In contrast to acetyl-CoA thiolase, AACS-catalyzed acetoacetyl-CoA synthesis is essentially an energy-favored reaction, due to the associated decarboxylation of malonyl-CoA. In addition, AACS exhibits no thiolysis activity against acetoacetyl-CoA, and thus the reaction is irreversible.

In cells expressing acetyl-CoA thiolase and a heterologous ADA and/or phosphotransacetylase (PTA), the reversible reaction catalyzed by acetyl-CoA thiolase, which favors acetoacetyl-CoA thiolysis, may result in a large acetyl-CoA pool. In view of the reversible activity of ADA, this acetyl-CoA pool may in turn drive ADA towards the reverse reaction of converting acetyl-CoA to acetaldehyde, thereby diminishing the benefits provided by ADA towards acetyl-CoA production. Similarly, the activity of PTA is reversible, and thus, a large acetyl-CoA pool may drive PTA towards the reverse reaction of converting acetyl-CoA to acetyl phosphate. Therefore, in some embodiments, in order to provide a strong pull on acetyl-CoA to drive the forward reaction of ADA and PTA, the MEV pathway of the genetically modified host cell provided herein utilizes an acetoacetyl-CoA synthase to form acetoacetyl-CoA from acetyl-CoA and malonyl-CoA.

The AACS obtained from Streptomyces sp. Strain CL190 may be used (see Okamura et al., (2010), PNAS, vol. 107, pp. 11265-11270). Representative AACS encoding nucleic acids sequences from Streptomyces sp. Strain CL190 include the sequence of accession no. AB540131.1, and the corresponding AACS protein sequences include the sequence of accession nos. D7URV0 and BAJ10048. Other acetoacetyl-CoA synthases useful for the invention include those of Streptomyces sp. (see accession nos. AB183750; KO-3988 BAD86806; KO-3988 AB212624; and KO-2988 BAE78983); S. anulatus strain 9663 (see accession nos. FN178498 and CAX48662); Actinoplanes sp. A40644 (see accession nos. AB113568 and BAD07381); Streptomyces sp. C (see accession nos. NZ_ACEW010000640 and ZP_05511702); Nocardiopsis dassonvillei DSM 43111 (see accession nos. NZ_ABUI01000023 and ZP_04335288); Mycobacterium ulcerans Agy99 (see accession nos. NC_008611 and YP_907152); Mycobacterium marinum M (see accession nos. NC_010612 and YP_001851502); Streptomyces sp. Mg1 (see accession nos. NZ_DS570501 and ZP_05002626); Streptomyces sp. AA4 (see accession nos. NZ_ACEV01000037 and ZP_05478992); S. roseosporus NRRL 15998 (see accession nos. NZ_ABYB01000295 and ZP_04696763); Streptomyces sp. ACTE (see accession nos. NZ_ADFD01000030 and ZP_06275834); S. viridochromogenes DSM 40736 (see accession nos. NZ_ACEZ01000031 and ZP_05529691); Frankia sp. CcI3 (see accession nos. NC_007777 and YP_480101); Nocardia brasiliensis (see accession nos. NC_018681 and YP_006812440.1); and Austwickia chelonae (see accession nos. NZ_BAGZ01000005 and ZP_10950493.1). Additional suitable acetoacetyl-CoA synthases include those described in U.S. Patent Application Publication Nos. 2010/0285549 and 2011/0281315.

Acetoacetyl-CoA synthases also useful in the compositions and methods provided herein include those molecules which are said to be “derivatives” of any of the acetoacetyl-CoA synthases described herein. Such a “derivative” has the following characteristics: (1) it shares substantial homology with any of the acetoacetyl-CoA synthases described herein; and (2) is capable of catalyzing the irreversible condensation of acetyl-CoA with malonyl-CoA to form acetoacetyl-CoA. A derivative of an acetoacetyl-CoA synthase is said to share “substantial homology” with acetoacetyl-CoA synthase if the amino acid sequences of the derivative is at least 80%, and more preferably at least 90%, and most preferably at least 95%, the same as that of acetoacetyl-CoA synthase.

### Conversion of Acetoacetyl-CoA to HMG-CoA

In some embodiments, the host cell comprises a heterologous nucleotide sequence encoding an enzyme that can condense acetoacetyl-CoA with another molecule of acetyl-CoA to form 3-hydroxy-3-methylglutaryl-CoA (HMG-CoA), e.g., a HMG-CoA synthase. Examples of nucleotide sequences encoding such an enzyme include: (NC_001145. complement 19061.20536; Saccharomyces cerevisiae), (X96617; Saccharomyces cerevisiae), (X83882; Arabidopsis thaliana), (AB037907; Kitasatospora griseola), (BT007302; Homo sapiens), and (NC_002758, Locus tag SAV2546, GeneID 1122571; Staphylococcus aureus).

### Conversion of HMG-CoA to Mevalonate

In some embodiments, the host cell comprises a heterologous nucleotide sequence encoding an enzyme that can convert HMG-CoA into mevalonate, e.g., a HMG-CoA reductase. The HMG-CoA reductase may be an NADH-using hydroxymethylglutaryl-CoA reductase-CoA reductase. HMG-CoA reductases (EC 1.1.1.34; EC 1.1.1.88) catalyze the reductive deacylation of (S)-HMG-CoA to (R)-mevalonate, and can be categorized into two classes, class I and class II HMGrs. Class I includes the enzymes from eukaryotes and most archaea, and class II includes the HMG-CoA reductases of certain prokaryotes and archaea. In addition to the divergence in the sequences, the enzymes of the two classes also differ with regard to their cofactor specificity. Unlike the class I enzymes, which utilize NADPH exclusively, the class II HMG-CoA reductases vary in the ability to discriminate between NADPH and NADH (See, e.g., Hedl et al., (2004) Journal of Bacteriology, vol. 186, pp. 1927-1932).

HMG-CoA reductases useful for the invention include HMG-CoA reductases that are capable of utilizing NADH as a cofactor, e.g., HMG-CoA reductase from P. mevalonii, A. fulgidus, or S. aureus. In particular embodiments, the HMG-CoA reductase is capable of only utilizing NADH as a cofactor, e.g., HMG-CoA reductase from P. mevalonii, S. pomeroyi, or D. acidovorans.

In some embodiments, the NADH-using HMG-CoA reductase is from Pseudomonas mevalonii. The sequence of the wild-type mvaA gene of Pseudomonas mevalonii, which encodes HMG-CoA reductase (EC 1.1.1.88), has been previously described (see Beach and Rodwell, (1989), J. Bacteriol., vol. 171, pp. 2994-3001). Representative mvaA nucleotide sequences of Pseudomonas mevalonii include accession number M24015. Representative HMG-CoA reductase protein sequences of Pseudomonas mevalonii include accession numbers AAA25837, P13702, MVAA_PSEMV.

In some embodiments, the NADH-using HMG-CoA reductase is from Silicibacter pomeroyi. Representative HMG-CoA reductase nucleotide sequences of Silicibacter pomeroyi include accession number NC_006569.1. Representative HMG-CoA reductase protein sequences of Silicibacter pomeroyi include accession number YP_164994.

In some embodiments, the NADH-using HMG-CoA reductase is from Delftia acidovorans. A representative HMG-CoA reductase nucleotide sequences of Delftia acidovorans includes NC_010002 REGION: complement (319980 . . . 321269). Representative HMG-CoA reductase protein sequences of Delftia acidovorans include accession number YP_001561318.

In some embodiments, the NADH-using HMG-CoA reductase is from Solanum tuberosum (see Crane et al., (2002), J. Plant Physiol., vol. 159, pp. 1301-1307).

NADH-using HMG-CoA reductases useful in the practice of the invention also include those molecules which are said to be “derivatives” of any of the NADH-using HMG-CoA reductases described herein, e.g., from P. mevalonii, S. pomeroyi and D. acidovorans. Such a “derivative” has the following characteristics: (1) it shares substantial homology with any of the NADH-using HMG-CoA reductases described herein; and (2) is capable of catalyzing the reductive deacylation of (S)-HMG-CoA to (R)-mevalonate while preferentially using NADH as a cofactor. A derivative of an NADH-using HMG-CoA reductase is said to share “substantial homology” with NADH-using HMG-CoA reductase if the amino acid sequences of the derivative is at least 80%, and more preferably at least 90%, and most preferably at least 95%, the same as that of NADH-using HMG-CoA reductase.

As used herein, the phrase “NADH-using” means that the NADH-using HMG-CoA reductase is selective for NADH over NADPH as a cofactor, for example, by demonstrating a higher specific activity for NADH than for NADPH. The selectivity for NADH as a cofactor is expressed as a k_{cat}^{(NADH)}/k_{cat}^{(NADPH)} ratio. The NADH-using HMG-CoA reductase of the invention may have a k_{cat}^{(NADH)}/k_{cat}^{(NADPH)} ratio of at least 5, 10, 15, 20, 25 or greater than 25. The NADH-using HMG-CoA reductase may use NADH exclusively. For example, an NADH-using HMG-CoA reductase that uses NADH exclusively displays some activity with NADH supplied as the sole cofactor in vitro, and displays no detectable activity when NADPH is supplied as the sole cofactor. Any method for determining cofactor specificity known in the art can be utilized to identify HMG-CoA reductases having a preference for NADH as cofactor (see e.g., (Kim et al., (2000), Protein Science, vol. 9, pp. 1226-1234) and (Wilding et al., (2000), J. Bacteriol., vol. 182, pp. 5147-5152).

In some cases, the NADH-using HMG-CoA reductase is engineered to be selective for NADH over NAPDH, for example, through site-directed mutagenesis of the cofactor-binding pocket. Methods for engineering NADH-selectivity are described in Watanabe et al., (2007), Microbiology, vol. 153, pp. 3044-3054), and methods for determining the cofactor specificity of HMG-CoA reductases are described in Kim et al., (2000), Protein Sci., vol. 9, pp. 1226-1234).\

The NADH-using HMG-CoA reductase may be derived from a host species that natively comprises a mevalonate degradative pathway, for example, a host species that catabolizes mevalonate as its sole carbon source. In these cases, the NADH-using HMG-CoA reductase, which normally catalyzes the oxidative acylation of internalized (R)-mevalonate to (S)-HMG-CoA within its native host cell, is utilized to catalyze the reverse reaction, that is, the reductive deacylation of (S)-HMG-CoA to (R)-mevalonate, in a genetically modified host cell comprising a mevalonate biosynthetic pathway. Prokaryotes capable of growth on mevalonate as their sole carbon source have been described by: (Anderson et al., (1989), J. Bacteriol, vol. 171, pp. 6468-6472); (Beach et al., (1989), J. Bacteriol., vol. 171, pp. 2994-3001); Bensch et al., J. Biol. Chem., vol. 245, pp. 3755-3762); (Fimongnari et al., (1965), Biochemistry, vol. 4, pp. 2086-2090); Siddiqi et al., (1962), Biochem. Biophys. Res. Commun., vol. 8, pp. 110-113); (Siddiqi et al., (1967), J. Bacteriol., vol. 93, pp. 207-214); and (Takatsuji et al., (1983), Biochem. Biophys. Res. Commun., vol. 110, pp. 187-193).

The host cell may contain both a NADH-using HMGr and an NADPH-using HMG-CoA reductase. Examples of nucleotide sequences encoding an NADPH-using HMG-CoA reductase include: (NM_206548; Drosophila melanogaster), (NC_002758, Locus tag SAV2545, GeneID 1122570; Staphylococcus aureus), (AB015627; Streptomyces sp. KO 3988), (AX128213, providing the sequence encoding a truncated HMG-CoA reductase; Saccharomyces cerevisiae), and (NC_001145: complement (115734.118898; Saccharomyces cerevisiae).

### Conversion of Mevalonate to Mevalonate-5-Phosphate

The host cell may contain a heterologous nucleotide sequence encoding an enzyme that can convert mevalonate into mevalonate 5-phosphate, e.g., a mevalonate kinase. Illustrative examples of nucleotide sequences encoding such an enzyme include: (L77688; Arabidopsis thaliana) and (X55875; Saccharomyces cerevisiae).

### Conversion of Mevalonate-5-Phosphate to Mevalonate-5-Pyrophosphate

The host cell may contain a heterologous nucleotide sequence encoding an enzyme that can convert mevalonate 5-phosphate into mevalonate 5-pyrophosphate, e.g., a phosphomevalonate kinase. Illustrative examples of nucleotide sequences encoding such an enzyme include: (AF429385; Hevea brasiliensis), (NM_006556; Homo sapiens), and (NC_001145. complement 712315.713670; Saccharomyces cerevisiae).

### Conversion of Mevalonate-5-Pyrophosphate to IPP

The host cell may contain a heterologous nucleotide sequence encoding an enzyme that can convert mevalonate 5-pyrophosphate into isopentenyl diphosphate (IPP), e.g., a mevalonate pyrophosphate decarboxylase. Illustrative examples of nucleotide sequences encoding such an enzyme include: (X97557; Saccharomyces cerevisiae), (AF290095; Enterococcus faecium), and (U49260; Homo sapiens).

### Conversion of IPP to DMAPP

The host cell may contain a heterologous nucleotide sequence encoding an enzyme that can convert IPP generated via the MEV pathway into dimethylallyl pyrophosphate (DMAPP), e.g., an IPP isomerase. Illustrative examples of nucleotide sequences encoding such an enzyme include: (NC_000913, 3031087.3031635; Escherichia coli), and (AF082326; Haematococcus pluvialis).

### Polyprenyl Synthases

In some embodiments, the host cell further comprises a heterologous nucleotide sequence encoding a polyprenyl synthase that can condense IPP and/or DMAPP molecules to form polyprenyl compounds containing more than five carbons.

The host cell may contain a heterologous nucleotide sequence encoding an enzyme that can condense one molecule of IPP with one molecule of DMAPP to form one molecule of geranyl pyrophosphate (“GPP”), e.g., a GPP synthase. Non-limiting examples of nucleotide sequences encoding such an enzyme include: (AF513111; Abies grandis), (AF513112; Abies grandis), (AF513113; Abies grandis), (AY534686; Antirrhinum majus), (AY534687; Antirrhinum majus), (Y17376; Arabidopsis thaliana), (AE016877, Locus AP11092; Bacillus cereus; ATCC 14579), (AJ243739; Citrus sinensis), (AY534745; Clarkia breweri), (AY953508; Ips pini), (DQ286930; Lycopersicon esculentum), (AF182828; Mentha×piperita), (AF182827; Mentha×piperita), (MPI249453; Mentha×piperita), (PZE431697, Locus CAD24425; Paracoccus zeaxanthinifaciens), (AY866498; Picrorhiza kurrooa), (AY351862; Vitis vinifera), and (AF203881, Locus AAF12843; Zymomonas mobilis).

The host cell may contain a heterologous nucleotide sequence encoding an enzyme that can condense two molecules of IPP with one molecule of DMAPP, or add a molecule of IPP to a molecule of GPP, to form a molecule of farnesyl pyrophosphate (“FPP”), e.g., a FPP synthase. Non-limiting examples of nucleotide sequences that encode a FPP synthase include: (ATU80605; Arabidopsis thaliana), (ATHFPS2R; Arabidopsis thaliana), (AAU36376; Artemisia annua), (AF461050; Bos taurus), (D00694; Escherichia coli K-12), (AE009951, Locus AAL95523; Fusobacterium nucleatum subsp. nucleatum ATCC 25586), (GFFPPSGEN; Gibberella fujikuroi), (CP000009, Locus AAW60034; Gluconobacter oxydans 621H), (AF019892; Helianthus annuus), (HUMFAPS; Homo sapiens), (KLPFPSQCR; Kluyveromyces lactis), (LAU15777; Lupinus albus), (LAU20771; Lupinus albus), (AF309508; Mus musculus), (NCFPPSGEN; Neurospora crassa), (PAFPS1; Parthenium argentatum), (PAFPS2; Parthenium argentatum), (RATFAPS; Rattus norvegicus), (YSCFPP; Saccharomyces cerevisiae), (D89104; Schizosaccharomyces pombe), (CP000003, Locus AAT87386; Streptococcus pyogenes), (CP000017, Locus AAZ51849; Streptococcus pyogenes), (NC_008022, Locus YP_598856; Streptococcus pyogenes MGAS10270), (NC_008023, Locus YP_600845; Streptococcus pyogenes MGAS2096), (NC_008024, Locus YP_602832; Streptococcus pyogenes MGAS10750), (MZEFPS; Zea mays), (AE000657, Locus AAC06913; Aquifex aeolicus VF5), (NM_202836; Arabidopsis thaliana), (D84432, Locus BAA12575; Bacillus subtilis), (U12678, Locus AAC28894; Bradyrhizobium japonicum USDA 110), (BACFDPS; Geobacillus stearothermophilus), (NC_002940, Locus NP_873754; Haemophilus ducreyi 35000HP), (L42023, Locus AAC23087; Haemophilus influenzae Rd KW20), (J05262; Homo sapiens), (YP_395294; Lactobacillus sakei subsp. sakei 23K), (NC_005823, Locus YP_000273; Leptospira interrogans serovar Copenhageni str. Fiocruz L1-130), (AB003187; Micrococcus luteus), (NC_002946, Locus YP_208768; Neisseria gonorrhoeae FA 1090), (U00090, Locus AAB91752; Rhizobium sp. NGR234), (J05091; Saccharomyces cerevisae), (CP000031, Locus AAV93568; Silicibacter pomeroyi DSS-3), (AE008481, Locus AAK99890; Streptococcus pneumoniae R6), and (NC_004556, Locus NP 779706; Xylella fastidiosa Temecula1).

In addition, the host cell may contain a heterologous nucleotide sequence encoding an enzyme that can combine IPP and DMAPP or IPP and FPP to form geranylgeranyl pyrophosphate (“GGPP”). Non-limiting examples of nucleotide sequences that encode such an enzyme include: (ATHGERPYRS; Arabidopsis thaliana), (BT005328; Arabidopsis thaliana), (NM_119845; Arabidopsis thaliana), (NZ_AAJM01000380, Locus ZP_00743052; Bacillus thuringiensis serovar israelensis, ATCC 35646 sq1563), (CRGGPPS; Catharanthus roseus), (NZ_AABF02000074, Locus ZP_00144509; Fusobacterium nucleatum subsp. vincentii, ATCC 49256), (GFGGPPSGN; Gibberella fujikuroi), (AY371321; Ginkgo biloba), (AB055496; Hevea brasiliensis), (AB017971; Homo sapiens), (MCI276129; Mucor circinelloides f. lusitanicus), (AB016044; Mus musculus), (AABX01000298, Locus NCU01427; Neurospora crassa), (NCU20940; Neurospora crassa), (NZ_AAKL01000008, Locus ZP_00943566; Ralstonia solanacearum UW551), (AB 118238; Rattus norvegicus), (SCU31632; Saccharomyces cerevisiae), (AB016095; Synechococcus elongates), (SAGGPS; Sinapis alba), (SSOGDS; Sulfolobus acidocaldarius), (NC_007759, Locus YP_461832; Syntrophus aciditrophicus SB), (NC_006840, Locus YP_204095; Vibrio fischeri ES114), (NM_112315; Arabidopsis thaliana), (ERWCRTE; Pantoea agglomerans), (D90087, Locus BAA14124; Pantoea ananatis), (X52291, Locus CAA36538; Rhodobacter capsulatus), (AF195122, Locus AAF24294; Rhodobacter sphaeroides), and (NC_004350, Locus NP_721015; Streptococcus mutans UA159).

While examples of the enzymes of the mevalonate pathway are described above, in certain embodiments, enzymes of the DXP pathway can be used as an alternative or additional pathway to produce DMAPP and IPP in the host cells, compositions and methods described herein. Enzymes and nucleic acids encoding the enzymes of the DXP pathway are well-known and characterized in the art, e.g., WO 2012/135591.

### Methods of Producing Rebaudioside M

The invention provides for the production of a high-intensity sweetener comprising greater than 95% rebaudioside M by (a) culturing a population of any of the genetically modified host cells described herein that are capable of producing rebaudioside M in a medium with a carbon source under conditions suitable for making rebaudioside M, and (b) recovering the rebaudioside M from the medium at a purity greater than 95%.

The genetically modified host cell produces an increased amount of the rebaudioside M compared to a parent cell not having the genetic modifications, or a parent cell having only a subset of the genetic modifications, but is otherwise genetically identical. In some embodiments, the host cell may produce an elevated level of rebaudioside M that is greater than about 1 gram per liter of fermentation medium. In some embodiments, the host cell produces an elevated level of rebaudioside M that is greater than about 5 grams per liter of fermentation medium. In some embodiments, the host cell produces an elevated level of rebaudioside M that is greater than about 10 grams per liter of fermentation medium. In some embodiments, rebaudioside M is produced in an amount from about 10 to about 50 grams, from about 10 to about 15 grams, more than about 15 grams, more than about 20 grams, more than about 25 grams, or more than about 40 grams per liter of cell culture.

In some embodiments, the host cell produces an elevated level of rebaudioside M that is greater than about 50 milligrams per gram of dry cell weight. In some such embodiments, rebaudioside M is produced in an amount from about 50 to about 1500 milligrams, more than about 100 milligrams, more than about 150 milligrams, more than about 200 milligrams, more than about 250 milligrams, more than about 500 milligrams, more than about 750 milligrams, or more than about 1000 milligrams per gram of dry cell weight.

In most embodiments, the production of the elevated level of rebaudioside M by the host cell is inducible by the presence of an inducing compound. Such a host cell can be manipulated with ease in the absence of the inducing compound. The inducing compound is then added to induce the production of the elevated level of rebaudioside M by the host cell. In other embodiments, production of the elevated level of steviol glycoside by the host cell is inducible by changing culture conditions, such as, for example, the growth temperature, media constituents, and the like.

### Culture Media and Conditions

Materials and methods for the maintenance and growth of microbial cultures are well known to those skilled in the art of microbiology or fermentation science (see, for example, Bailey et al., Biochemical Engineering Fundamentals, second edition, McGraw Hill, New York, 1986). Consideration must be given to appropriate culture medium, pH, temperature, and requirements for aerobic, microaerobic, or anaerobic conditions, depending on the specific requirements of the host cell, the fermentation, and the process.

The methods of producing rebaudioside M provided herein may be performed in a suitable culture medium (e.g., with or without pantothenate supplementation) in a suitable container, including but not limited to a cell culture plate, a microtiter plate, a flask, or a fermentor. Further, the methods can be performed at any scale of fermentation known in the art to support industrial production of microbial products. Any suitable fermentor may be used including a stirred tank fermentor, an airlift fermentor, a bubble fermentor, or any combination thereof. In particular embodiments utilizing Saccharomyces cerevisiae as the host cell, strains can be grown in a fermentor as described in detail by Kosaric, et al, in Ullmann's Encyclopedia of Industrial Chemistry, Sixth Edition, vol. 12, pp. 398-473, Wiley-VCH Verlag GmbH & Co. KDaA, Weinheim, Germany.

In some embodiments, the culture medium is any culture medium in which a genetically modified microorganism capable of producing rebaudioside M can subsist. The culture medium may be an aqueous medium comprising assimilable carbon, nitrogen and phosphate sources.

Such a medium can also include appropriate salts, minerals, metals, and other nutrients. The carbon source and each of the essential cell nutrients may be added incrementally or continuously to the fermentation media, and each required nutrient may be maintained at essentially the minimum level needed for efficient assimilation by growing cells, for example, in accordance with a predetermined cell growth curve based on the metabolic or respiratory function of the cells which convert the carbon source to a biomass.

Suitable conditions and suitable media for culturing microorganisms are well known in the art. For example, the suitable medium may be supplemented with one or more additional agents, such as, for example, an inducer (e.g., when one or more nucleotide sequences encoding a gene product are under the control of an inducible promoter), a repressor (e.g., when one or more nucleotide sequences encoding a gene product are under the control of a repressible promoter), or a selection agent (e.g., an antibiotic to select for microorganisms comprising the genetic modifications).

The carbon source may be a monosaccharide (simple sugar), a disaccharide, a polysaccharide, a non-fermentable carbon source, or one or more combinations thereof. Non-limiting examples of suitable monosaccharides include glucose, galactose, mannose, fructose, xylose, ribose, and combinations thereof. Non-limiting examples of suitable disaccharides include sucrose, lactose, maltose, trehalose, cellobiose, and combinations thereof. Non-limiting examples of suitable polysaccharides include starch, glycogen, cellulose, chitin, and combinations thereof. Non-limiting examples of suitable non-fermentable carbon sources include acetate and glycerol.

The concentration of a carbon source, such as glucose, in the culture medium may be sufficient to promote cell growth but is not so high as to repress growth of the microorganism used. Typically, cultures are run with a carbon source, such as glucose, being added at levels to achieve the desired level of growth and biomass. The concentration of a carbon source, such as glucose, in the culture medium may be greater than about 1 g/L, preferably greater than about 2 g/L, and more preferably greater than about 5 g/L. In addition, the concentration of a carbon source, such as glucose, in the culture medium is typically less than about 100 g/L, preferably less than about 50 g/L, and more preferably less than about 20 g/L. It should be noted that references to culture component concentrations can refer to both initial and/or ongoing component concentrations. In some cases, it may be desirable to allow the culture medium to become depleted of a carbon source during culture.

Sources of assimilable nitrogen that can be used in a suitable culture medium include simple nitrogen sources, organic nitrogen sources and complex nitrogen sources. Such nitrogen sources include anhydrous ammonia, ammonium salts and substances of animal, vegetable and/or microbial origin. Suitable nitrogen sources include protein hydrolysates, microbial biomass hydrolysates, peptone, yeast extract, ammonium sulfate, urea, and amino acids. Typically, the concentration of the nitrogen sources, in the culture medium is greater than about 0.1 g/L, preferably greater than about 0.25 g/L, and more preferably greater than about 1.0 g/L. Beyond certain concentrations, however, the addition of a nitrogen source to the culture medium is not advantageous for the growth of the microorganisms. As a result, the concentration of the nitrogen sources, in the culture medium is less than about 20 g/L, preferably less than about 10 g/L and more preferably less than about 5 g/L. Further, in some instances it may be desirable to allow the culture medium to become depleted of the nitrogen sources during culture.

The effective culture medium may contain other compounds such as inorganic salts, vitamins, trace metals or growth promoters. Such other compounds may also be present in carbon, nitrogen or mineral sources in the effective medium or can be added specifically to the medium.

The culture medium may also contain a suitable phosphate source. Such phosphate sources include both inorganic and organic phosphate sources. Preferred phosphate sources include phosphate salts such as mono or dibasic sodium and potassium phosphates, ammonium phosphate and mixtures thereof. Typically, the concentration of phosphate in the culture medium is greater than about 1.0 g/L, preferably greater than about 2.0 g/L and more preferably greater than about 5.0 g/L. Beyond certain concentrations, however, the addition of phosphate to the culture medium is not advantageous for the growth of the microorganisms. Accordingly, the concentration of phosphate in the culture medium is typically less than about 20 g/L, preferably less than about 15 g/L and more preferably less than about 10 g/L.

A suitable culture medium can also include a source of magnesium, preferably in the form of a physiologically acceptable salt, such as magnesium sulfate heptahydrate, although other magnesium sources in concentrations that contribute similar amounts of magnesium can be used. Typically, the concentration of magnesium in the culture medium is greater than about 0.5 g/L, preferably greater than about 1.0 g/L, and more preferably greater than about 2.0 g/L. Beyond certain concentrations, however, the addition of magnesium to the culture medium is not advantageous for the growth of the microorganisms. Accordingly, the concentration of magnesium in the culture medium is typically less than about 10 g/L, preferably less than about 5 g/L, and more preferably less than about 3 g/L. Further, in some instances it may be desirable to allow the culture medium to become depleted of a magnesium source during culture.

The culture medium can also include a biologically acceptable chelating agent, such as the dihydrate of trisodium citrate. In such instance, the concentration of a chelating agent in the culture medium is greater than about 0.2 g/L, preferably greater than about 0.5 g/L, and more preferably greater than about 1 g/L. Beyond certain concentrations, however, the addition of a chelating agent to the culture medium is not advantageous for the growth of the microorganisms. Accordingly, the concentration of a chelating agent in the culture medium is typically less than about 10 g/L, preferably less than about 5 g/L, and more preferably less than about 2 g/L.

The culture medium may also initially include a biologically acceptable acid or base to maintain the desired pH of the culture medium. Biologically acceptable acids include, but are not limited to, hydrochloric acid, sulfuric acid, nitric acid, phosphoric acid and mixtures thereof. Biologically acceptable bases include, but are not limited to, ammonium hydroxide, sodium hydroxide, potassium hydroxide and mixtures thereof. In some embodiments, the base used is ammonium hydroxide.

The culture medium may also include a biologically acceptable calcium source, including, but not limited to, calcium chloride. Typically, the concentration of the calcium source, such as calcium chloride, dihydrate, in the culture medium is within the range of from about 5 mg/L to about 2000 mg/L, preferably within the range of from about 20 mg/L to about 1000 mg/L, and more preferably in the range of from about 50 mg/L to about 500 mg/L.

The culture medium may also include sodium chloride. Typically, the concentration of sodium chloride in the culture medium is within the range of from about 0.1 g/L to about 5 g/L, preferably within the range of from about 1 g/L to about 4 g/L, and more preferably in the range of from about 2 g/L to about 4 g/L.

The culture medium may also include trace metals. Such trace metals can be added to the culture medium as a stock solution that, for convenience, can be prepared separately from the rest of the culture medium. Typically, the amount of such a trace metals solution added to the culture medium is greater than about 1 ml/L, preferably greater than about 5 mL/L, and more preferably greater than about 10 mL/L. Beyond certain concentrations, however, the addition of a trace metals to the culture medium is not advantageous for the growth of the microorganisms. Accordingly, the amount of such a trace metals solution added to the culture medium is typically less than about 100 mL/L, preferably less than about 50 mL/L, and more preferably less than about 30 mL/L. It should be noted that, in addition to adding trace metals in a stock solution, the individual components can be added separately, each within ranges corresponding independently to the amounts of the components dictated by the above ranges of the trace metals solution.

The culture media may include other vitamins, such as pantothenate, biotin, calcium, pantothenate, inositol, pyridoxine-HCl, and thiamine-HCl. Such vitamins can be added to the culture medium as a stock solution that, for convenience, can be prepared separately from the rest of the culture medium. Beyond certain concentrations, however, the addition of vitamins to the culture medium is not advantageous for the growth of the microorganisms.

The fermentation methods described herein can be performed in conventional culture modes, which include, but are not limited to, batch, fed-batch, cell recycle, continuous and semi-continuous. In some embodiments, the fermentation is carried out in fed-batch mode. In such a case, some of the components of the medium are depleted during culture, including pantothenate during the production stage of the fermentation. In some embodiments, the culture may be supplemented with relatively high concentrations of such components at the outset, for example, of the production stage, so that growth and/or steviol glycoside production is supported for a period of time before additions are required. The preferred ranges of these components are maintained throughout the culture by making additions as levels are depleted by culture. Levels of components in the culture medium can be monitored by, for example, sampling the culture medium periodically and assaying for concentrations. Alternatively, once a standard culture procedure is developed, additions can be made at timed intervals corresponding to known levels at particular times throughout the culture. As will be recognized by those in the art, the rate of consumption of nutrient increases during culture as the cell density of the medium increases. Moreover, to avoid introduction of foreign microorganisms into the culture medium, addition is performed using aseptic addition methods, as are known in the art. In addition, an anti-foaming agent may be added during the culture.

The temperature of the culture medium can be any temperature suitable for growth of the genetically modified cells and/or production of steviol glycoside. For example, prior to inoculation of the culture medium with an inoculum, the culture medium can be brought to and maintained at a temperature in the range of from about 20° C. to about 45° C., preferably to a temperature in the range of from about 25° C. to about 40° C., and more preferably in the range of from about 28° C. to about 32° C. The pH of the culture medium can be controlled by the addition of acid or base to the culture medium. In such cases when ammonium hydroxide is used to control pH, it also conveniently serves as a nitrogen source in the culture medium. Preferably, the pH is maintained from about 3.0 to about 8.0, more preferably from about 3.5 to about 7.0, and most preferably from about 4.0 to about 6.5.

The carbon source concentration, such as the glucose concentration, of the culture medium is monitored during culture. Glucose concentration of the culture medium can be monitored using known techniques, such as, for example, use of the glucose oxidase enzyme test or high pressure liquid chromatography, which can be used to monitor glucose concentration in the supernatant, e.g., a cell-free component of the culture medium. The carbon source concentration is typically maintained below the level at which cell growth inhibition occurs. Although such concentration may vary from organism to organism, for glucose as a carbon source, cell growth inhibition occurs at glucose concentrations greater than at about 60 g/L, and can be determined readily by trial. Accordingly, when glucose is used as a carbon source the glucose is preferably fed to the fermentor and maintained below detection limits. Alternatively, the glucose concentration in the culture medium is maintained in the range of from about 1 g/L to about 100 g/L, more preferably in the range of from about 2 g/L to about 50 g/L, and yet more preferably in the range of from about 5 g/L to about 20 g/L. Although the carbon source concentration can be maintained within desired levels by addition of, for example, a substantially pure glucose solution, it is acceptable, and may be preferred, to maintain the carbon source concentration of the culture medium by addition of aliquots of the original culture medium. The use of aliquots of the original culture medium may be desirable because the concentrations of other nutrients in the medium (e.g. the nitrogen and phosphate sources) can be maintained simultaneously. Likewise, the trace metals concentrations can be maintained in the culture medium by addition of aliquots of the trace metals solution.

Other suitable fermentation medium and methods are described in, e.g., WO 2016/196321.

### Recovery of Steviol Glycosides

Once the steviol glycoside is produced by the host cell, it may be recovered or isolated for subsequent use using any suitable separation and purification methods known in the art. For example, a clarified aqueous phase containing the steviol glycoside may be separated from the fermentation by centrifugation. Alternatively, a clarified aqueous phase containing the steviol glycoside may be separated from the fermentation by adding a demulsifier into the fermentation reaction. Examples of demulsifiers include flocculants and coagulants.

The steviol glycoside produced in the host cells may be present in the culture supernatant and/or associated with the host cells. Where some of the steviol glycoside is associated with the host cell, the recovery of the steviol glycoside may involve a method of improving the release of the steviol glycosides from the cells. This could take the form of washing the cells with hot water or buffer treatment, with or without a surfactant, and with or without added buffers or salts. The temperature may be any temperature deemed suitable for releasing the steviol glycosides. For example, the temperature may be in a range from 40 to 95° C.; or from 60 to 90° C.; or from 75 to 85° C. Alternatively, the temperature may be 40, 45, 50, 55, 65, 70, 75, 80, 85, 90, or 95° C. Physical or chemical cell disruption may be used to enhance the release of steviol glycosides from the host cell. Alternatively and/or subsequently, the steviol glycoside in the culture medium may be recovered using an isolation unit operations including, solvent extraction, membrane clarification, membrane concentration, adsorption, chromatography, evaporation, chemical derivatization, crystallization, and drying.

In preferred embodiments, rebaudioside M is produced by the host cells during a fermentation run. Once fermentation is complete, the fermentation broth is centrifuged to remove the host cells and other dense debris. The cleared broth is then diluted with water and the pH is adjusted to pH 10 by the addition of NaOH. The cleared broth is then subjected to ultrafiltration with a 20 kDa cutoff to separate larger solutes from the smaller steviol glycosides. The filtrate is pH adjusted with citric acid and subjected to nanofiltration with a 300-500 Da filter. The nanofiltration concentrates the Rebaudioside M which then crystalizes out of solution to form an acidic slurry. The acidic slurry is then subjected to a first filter press and washed with an acid wash. The acid washed material is subjected to a second filter press, resuspended in water and spray dried to form the final purified Rebaudioside M.

### EXAMPLES

### Example 1: Yeast Strain Capable of Producing Rebaudioside M

A yeast strain producing high levels of Rebaudioside M was generated. A farnesene production strain was created from a wild-type Saccharomyces cerevisiae strain (CEN.PK2) by expressing the genes of the mevalonate pathway under the control of GAL1 or GAL10 promoters. This strain comprised the following chromosomally integrated mevalonate pathway genes from S. cerevisiae: acetyl-CoA thiolase, HMG-CoA synthase, HMG-CoA reductase, mevalonate kinase, phosphomevalonate kinase, mevalonate pyrophosphate decarboxylase, and IPP:DMAPP isomerase. In addition, the strain contained multiple copies of farnesene synthase from Artemisia annua, also under the control of either GAL1 or GAL10 promoters. All heterologous genes described herein were codon optimized using publicly available or other suitable algorithms. The strain also contained a deletion of the GAL80 gene, and the ERGS gene encoding squalene synthase was downregulated by replacing the native promoter with promoter of the yeast gene MET3 (Westfall et al., Proc. Natl. Acad. Sci. USA 109(3), 2012, pp. E111-E118). Examples of how to create S. cerevisiae strains with high flux to isoprenoids are described in the U.S. Pat. Nos. 8,415,136 and 8,236,512 which are incorporated herein in their entireties.

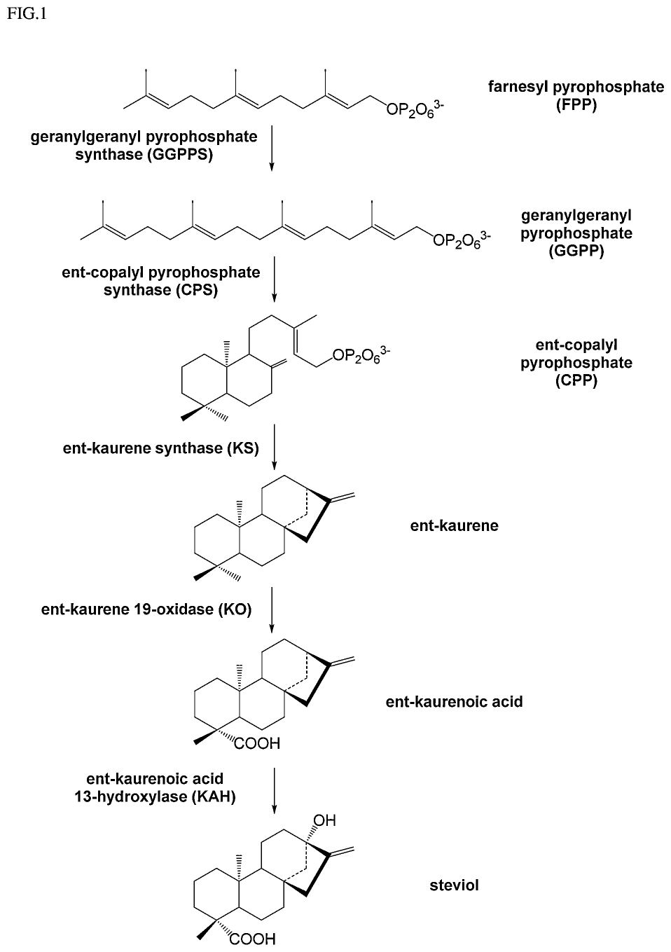

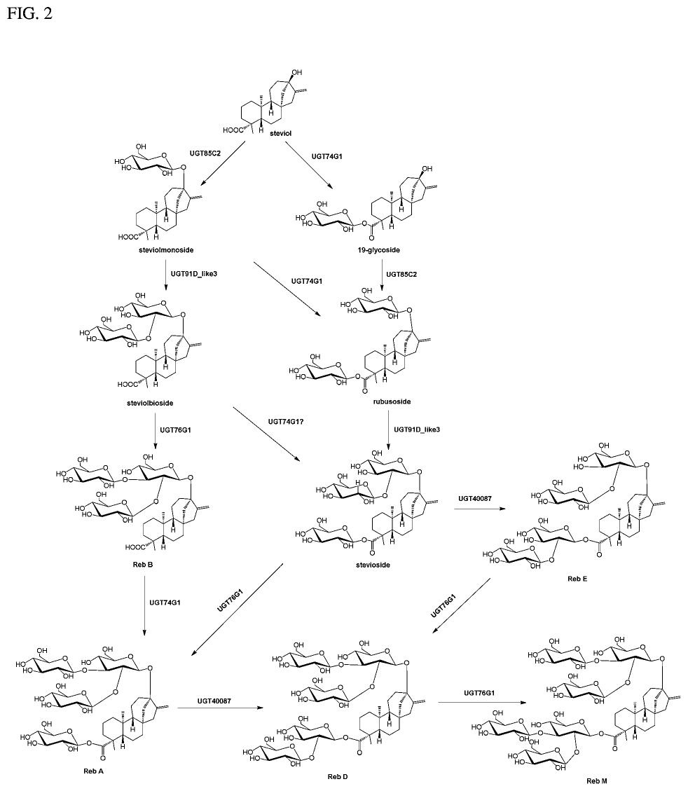

FIG. 1 shows an exemplary biosynthetic pathway from FPP to steviol. FIG. 2 shows an exemplary biosynthetic pathway from steviol to the glycoside Reb M. To convert the farnesene base strain described above to have high flux to the C20 isoprenoid kaurene, four copies of a geranylgeranylpyrophosphate synthase (GGPPS) were integrated into the genome, followed by two copies of a copalyldiphosphate synthase and a single copy of a kaurene synthase. At this point all copies of farnesene synthase were removed from the strain. Once the new strain was confirmed to make ent-kaurene, the remaining genes for converting ent-kaurene to Reb M were inserted into the genome. Table 1 lists all genes and promoters used to convert FPP to Reb M. Each gene after kaurene synthase was integrated as a single copy, except for the Sr.KAH enzyme for which two gene copies were integrated. The strain containing all genes described in Table 1 primarily produced Reb M.

TABLE 1
Genes, promoters, and amino acid sequences
of the enzymes used to convert FPP to Reb M.

| Enzyme name | SEQ ID | Promoter |
|---|---|---|
| Bt.GGPPS | SEQ ID NO: 9 | PGAL1 |
| ent-Os,CDPS | SEQ ID NO: 10¹ | PGAL1 |
| ent-Pg.Ks | SEQ ID NO: 11 | PGAL1 |
| Ps.KO | SEQ ID NO: 12 | PGAL1 |
| Sr.KAH | SEQ ID NO: 13 | PGAL1 |
| At.CPR | SEQ ID NO: 14 | PGAL3 |
| UGT85C2 | SEQ ID NO: 15 | PGAL10 |
| UGT74G1 | SEQ ID NO: 16 | PGAL1 |
| UGT91D_like3 | SEQ ID NO: 17 | PGAL1 |
| UGT76G1 | SEQ ID NO: 18 | PGAL10 |
| UGT40087 | SEQ ID NO: 19 | PGAL1 |

¹First 65 amino acids removed and replaced with methionine

### Example 2: Rebaudioside M Fermentation Process

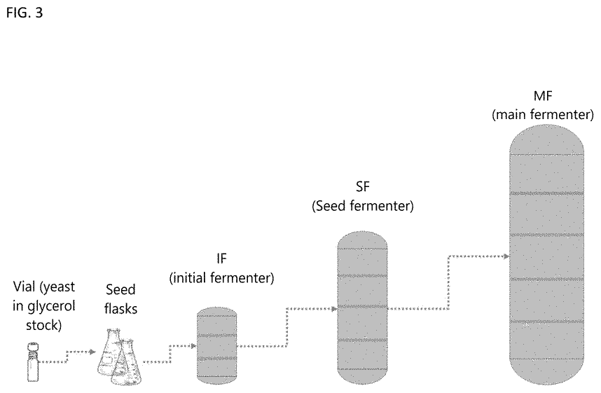

The fermentation process to obtain broth containing RebM is composed of the steps shown in FIG. 3. Each step gives the adequate conditions of pH, temperature, aeration and nutrients for yeast growth and production. The main conditions are summarized in Table 2 for each step and described in more detail below.

The process started from stocks of yeast in glycerol solution, stored at −70° C. To build up enough biomass to inoculate the production fermenter, there were 2 steps of culturing in flasks, and 2 steps of culturing in tanks. All fermenters were initiated with media (solution of nutrients), and were inoculated with culture from previous step. A concentrated feed solution of sugar from cane was provided in batch or fed-batch process, to allow the yeast to grow and/or produce RebM. The feed in the main fermenter (MF) tank was designed to keep the fermentation sugar-limited, it was delivered in pulses with dissolved oxygen spike checks unit final harvest at day 8 because of the long length of the process during production stage (8 days), and the tank being almost continuously fed, the volume increases, and partial draws were performed. All broth collected from partial draws and the harvest were processed through separation and purification units to generate the final purified RebM.

TABLE 2
Operational conditions for each step in the fermentation process to produce RebM-
containing broth

| | | Initial | Seed | Main |
|---|---|---|---|---|
| | | Fermenter | Fermenter | Fermenter |
| | Seed flasks | (IF) | (SF) | (MF) |
| Function | Yeast growth | Yeast growth | Yeast growth | RebM |
| | | | | production |
| Inoculation % | 2-4% | 0.2% | 4% | 35% |
| (v/v) | | | | |
| Temperature (° C.) | 28 | 30 | 30 | 30 |
| pH | 5 (by succinate | 5 (controlled | 5 (controlled | 5 (controlled |
| | buffer) | with NH₄OH) | with NH₄OH) | with NH₄OH) |
| Oxygen transfer | — | 30 | 80 | 120 |
| rate (mmol/L/h) | | | | |
| Feed process | Batch | Batch | Fed-batch | Fed-batch with |
| | | | | cycles of fill- |
| | | | | and-draw |
| Process length | 2 days | 1 day | 1 day | 8 days |
| Nutrients | Salts, Metals, | Salts, Metals, | Salts, Metals, | Salts, Metals, |
| | Vitamins, | Vitamins, | Vitamins, | Vitamins |
| | Maltose, Lysine | Maltose, Lysine, | Maltose, Lysine, | |
| | | Yeast Extract | Yeast Extract | |

### Example 3: Rebaudioside M Purification Process

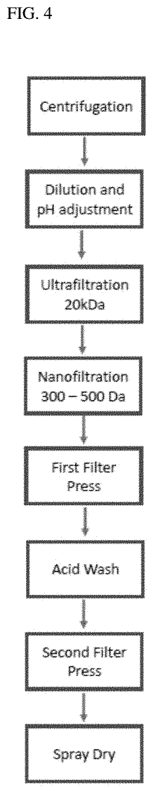

The overall RebM purification scheme is outlined in FIG. 4 and Table 3. The purification process started with the addition of water to the fermentation broth followed by heating to 75° C. to 80° C. to fully solubilize the RebM. The diluted fermentation broth was then centrifuged to separate the biomass and solids from the RebM containing supernatant phase (cleared fermentation broth). Following centrifugation, the cleared fermentation broth was subjected to ultrafiltration using a filter having a 20 kDa cut-off. The ultrafiltration removed larger and less soluble substrates from the RebM containing permeate. The permeate was then processed by nanofiltration with a filter system having a 300-500 Da cut-off. The nanofiltration step retained and concentrated the RebM while allowing water and monovalent salts to be removed. During nanofiltration a slurry enriched in RebM was produced. The slurry was collected by a first filter press. The collected slurry was then washed by the addition of a citric acid (3 to 4 pH) containing wash solution followed by a second filter press to remove the solid RebM from the acidic wash solution. Wetcake from both the first and second filter press were spray dried to produce powder. Three separate samples of purified RebM powder were analyzed by HPLC and mass spec to determine its steviol glycoside impurity profile as shown in Table 4. In particular, two samples were obtained after a single filter press (columns 1aFP-5 and 1aFP-6) and the third sample was obtained after the second filter press (2aFP-1). As shown, all three samples contained greater than 95% rebaudioside M by weight of dry material, and greater than 99% rebaudioside M as measured by total steviol glycoside content (TSG).

TABLE 3
List of unit operations and their desired function

| Step | Unit operation | Function |
|---|---|---|
| 1 | Extraction/Centrifuge | Extraction: H₂O dilution and heating (75-80° C.) to solubilize |
| | | Reb-M |
| | | Centrifugation: Separate biomass/solids from desired liquid |
| 2 | Ultrafiltration | Permeate Reb-M and retain all larger/less soluble species |
| | (20 kDa) | |
| 3 | Nanofiltration | Retain and crystallize Reb-M as monovalent salts and H₂O |
| | (300-500 Da) | are permeated |
| 4 | First Filter Press | Separate Reb-M solids from NF rctcntatc. Liquids contain |
| | | salts and upstream intermediates (with solubilized Reb-M) |
| 5 | Acidic Slurry | Slurry Reb-M solids (10-15% wt) with citric acid (pH 3-4) to |
| | | dissolve low solubility OH-salts (eg. Mg(OH)₂, Ca(OH)₂) |
| 6 | Second Filter Press | Separate washed Reb-M solids (15% wt) from acidic solution |
| 7 | Spray Drying | Sterilize and lower moisture content final product |

TABLE 4
Composition of dried purified high potency sweetener.

| | Measure- | | | | |
|---|---|---|---|---|---|
| | ment | | | | |
| Substance | Units | Specs | 1aFP-5 | 1aFP-6 | 2aFP-1 |
| RebM purity | % wt, dry | >95 | 95.4 +/− 0.4 | 97.9 +/− 0.4 | 98.5 +/− 1.2 |
| RebM/TSG | % | >95 | 99.4 | 99.6 | 99.7 |
| RebD/TSG | ppm | | 3200 | 2200 | 2500 |
| RebB/TSG | ppm | | 2000 | 800 | 100 |
| RebA/TSG | ppm | | 800 | 300 | 300 |
| RebE/TSG | ppm | | 0 | 0 | 0 |
| Kaurenoic | ppm | | 1440 | 0 | 600 |
| Acid | | | | | |
| Kaurene | ppm | | 21 | 0 | 0 |

### Example 4: Sugar Substitute

A sugar substitute containing 90% erythritol, 9.5% soluble fiber (Roquette NUTRIOSE FM10), and 0.5% purified rebaudioside M was prepared. In brief, 110 pounds of erythritol, 11.6 pounds of soluble fiber (Roquette NUTRIOSE FM10), and 0.79 pounds of greater than 95% rebaudioside M were obtained. Fifty-five pounds of erythritol was emptied into a 150-Lb mixer (Littleford horizontal screw mixer) and the mixer was run for two minutes at a plow speed of 30 to coat the mixer. 11.6 Lbs soluble fiber, 0.79 lbs>95% pure rebaudioside M, and 55 Lbs erythritol were sequentially added to the mixer. The plow speed was set to 30 and mixed for six minutes. The chopper was then set at plow speed 30 and mixed for two minutes. Ten ounces of distilled water was added to the sprayer and the plow speed set at 30 and mixed for an additional five minutes. The chopper plow speed was set at 30 and dried for 3 minutes under vacuum (−5 Hg or −0.2 BAR). The mixture was then loaded into a hopper attached to a bagger for bagging.

1. A purified high-intensity sweetener comprising at least 95% by weight Rebaudioside M and less than 20,000 ppm combined amount of Rebaudioside D, Rebaudioside B, and Rebaudioside A.

2. A purified high-intensity sweetener of claim 1 comprising less than 5000 ppm Rebaudioside D, less than 4000 ppm Rebaudioside B, and less than 2000 ppm Rebaudioside A.

3. The purified high-intensity sweetener of claim 1, wherein the Rebaudioside D is less than 3200 ppm, the Rebaudioside B is less than 2000 ppm, and the Rebaudioside A is less than 1000 ppm.

4. The purified high-intensity sweetener of claim 1, wherein the Rebaudioside D, Rebaudioside B, and Rebaudioside A are below the limit of quantification (LOQ) when also quantifying Rebaudioside M.

5. The purified high-intensity sweetener of claim 1, wherein Rebaudioside M, Rebaudioside D, Rebaudioside B, and Rebaudioside A amounts are measured using high performance liquid chromatography (HPLC).

6. (canceled)

7. (canceled)

8. (canceled)

9. A sugar substitute comprising the purified high-intensity sweetener of claim 1.

10. The sugar substitute of claim 9, further comprising one or more bulking agents.

11. The sugar substitute of claim 10, wherein the bulking agents are selected from erythritol, soluble fiber, dextrin, inulin, polydextrose, and maltodextrin.

12. (canceled)

13. (canceled)

14. (canceled)

15. (canceled)

16. (canceled)

17. (canceled)

18. A method of preparing the purified high-intensity sweetener of claim 1, comprising:
obtaining a cleared fermentation broth comprising rebaudioside M;
filtering the cleared fermentation broth with an ultrafilter to generate a ultrafiltration permeate;
filtering the ultrafiltration permeate with a nanofilter to generate a nanofiltration flow-through;
washing the nanofiltration flow-through; and
spray drying the washed nanofiltration flow-through to obtain the purified high-intensity sweetener of claim 1

19. The method of claim 18, wherein the ultrafilter has an ultrafiltration cutoff from about 2 kDa to about 100 kDa.

20. (canceled)

21. The method of claim 18, wherein the nanofilter has a nanofiltration cutoff from about 200 Da to about 1000 Da.

22. The method of claim 20, wherein the nanofilter has a nanofiltration cutoff of about 300 Da to about 500 Da.

23. The method of claim 18, wherein the cleared fermentation broth is pH adjusted to have a pH greater than pH7.

24. (canceled)

25. The method of claim 23, wherein the nanofiltration flow-through is washed after being acidified with an acid solution.

26. The method of claim 25, wherein the acid solution comprises citric acid.

27. A method of making the sugar substitute of claim 9, comprising:
adding a first bulking agent to a mixer;
precoating the mixer with the first bulking agent;
adding a second bulking agent, and the purified high-intensity sweetener of claim 1;
mixing the first bulking agent, second bulking agent, and high potency sweetener;
adding water to the mix;
mixing the first bulking agent, second bulking agent, high potency sweetener, and water;
drying the mixture.

28. The method of claim 27, wherein the first bulking agent is erythritol.

29. The method of claim 27, wherein the second bulking agent is a soluble fiber.

30. The method of claim 29, wherein the soluble fiber is digestion resistant dextrin.

31. The method of claim 30, wherein the digestion resistant dextrin is NUTRIOSE FM10.


SEQUENCE LISTING (15 sequences)

SEQ ID NO: 1 - protein, 523 aa, Saccharomyces cerevisiae
MEVTVGSWVALSLVFVSIIVGWAWSVLDWVWLKPKKLERCLREQGLKGNSYWFLYGDMKENSILLKQAKSKPMNLSTSHDIAPQVIPFVDQTVKVYGKNSFDWIGPIPRVNIMNPEELKDVFTKYDDFIKPISNPLFKLLATGLANYEGEKWAKHRRIINPTFHSEKLKRMLPSFHQSCTEMIKEWESLVSKEGSSCELDVWPFLENMTADVISRTAFGTSYKKGRKIFELLREQAIYATKAIQSFYIPGWRFLPTKMNKRMKEINKEIKGLIKGIIIKREHTIKAGEETKDDLLGALMESNLKDIREHGKNNKNFGMSIEDVIEECKLFYFAGQETTSVLLVWTMVLLGQNQNWQDRARQEILQVFGSNKPDFDGLTHLKVVTMILLEVLRLYPAVIELPRTIHKKTQLGKFSLPEGVEVRLPTLLIHHDKELWGDDANEFKPERFSEGVSKATKSRLSFFPFGGGPRICIGQNFAMMEAKLALVLILQHFTFELSPSYAHAPSYRITLQPQYGVPIILHRR

SEQ ID NO: 2 - DNA, 1571 bp, Saccharomyces cerevisiae
atggaagtaaccgttggatcttgggtagctttgtccttagtcttcgtttctattatcgtcggttgggcttggtccgttttagattgggtctggttgaaaccaaagaagttagaaagatgtttgagagaacaaggtttaaagggtaactcttactggttcttgtatggtgacatgaaagagaactctattttgttgaagcaagctaagtctaagccaatgaacttatctacctctcacgacatcgccccacaagttattccatttgtcgaccaaactgtcaaggtctacggtaagaactctttcgattggatcggtcctattccaagagtcaatatcatgaacccagaagaattgaaggatgttttcaccaagtacgatgacttcatcaagccaatttctaaccctttgttcaagttgttggctaccggtttggctaattacgaaggtgagaagtgggctaagcacagacgtattatcaacccaactttccattctgagaagttgaaaagaatgttgccatccttccaccaatcttgtactgaaatgatcaaggaatgggaatctttggtttctaaggaaggttcttcttgtgagttagacgtctggccattcttagaaaacatgaccgctgacgttatttctagaactgctttcggtacttcttacaagaagggtagaaagattttcgaattgttgagagaacaagctatttacgccaccaaggctatccaatctttttacattccaggttggcgttttttgcctactaaaatgaacaagagaatgaaggaaatcaacaaggagatcaagggtttgattaagggtatcatcatcaaaagagaacacactatcaaggctggtgaagaaactaaggatgacttgttaggtgctttgatggaatctaacttgaaggacattagagaacacggtaagaacaacaagaacttcggtatgtctatcgaagacgttatcgaagagtgtaagttgttctactttgctggtcaagaaactacttctgttttgttagtttggaccatggttttgttgggtcaaaatcaaaactggcaagatagagctagacaagaaatcttgcaagtttttggttctaataagccagacttcgatggtttgactcacttgaaagttgtcaccatgattttattggaagtcttgagattgtacccagctgttatcgaattgccaagaaccattcacaagaagactcaattgggtaaattctctttacctgaaggtgttgaagttagattgccaactttgttaatccaccatgataaggaattgtggggtgatgacgctaacgaattcaagccagaacgtttctctgaaggtgtttctaaggctaccaaatccagattgtccttttttcctttcggtggtggtcctagaatctgtattggtcaaaactttgctatgatggaagctaaattggctttggttttgattttgcaacacttcactttcgaattgtccccttcctacgcccatgctccatcctacagaattaccttacaacctcaatatggtgtccctattatcttgcaccgtcgtta

SEQ ID NO: 3 - protein, 320 aa, Saccharomyces cerevisiae
MLTSSKSIESFPKNVQPYGKHYQNGLEPVGKSQEDILLEPFHYLCSNPGKDVRTKMIEAFNAWLKVPKDDLIVITRVIEMLHSASLLIDDVEDDSVLRRGVPAAHHIYGTPQTINCANYVYFLALKEIAKLNKPNMITIYTDELINLHRGQGMELFWRDTLTCPTEKEFLDMVNDKTGGLLRLAVKLMQEASQSGTDYTGLVSKIGIHFQVRDDYMNLQSKNYADNKGFCEDLTEGKFSFPIIHSIRSDPSNRQLLNILKQRSSSIELKQFALQLLENTNTFQYCRDFLRVLEKEAREEIKLLGGNIMLEKIMDVLSVNE

SEQ ID NO: 4 - protein, 736 aa, Saccharomyces cerevisiae
MEHARPPQGGDDDVAASTSELPYMIESIKSKLRAARNSLGETTVSAYDTAWIALVNRLDGGGERSPQFPEAIDWIARNQLPDGSWGDAGMFIVQDRLINTLGCVVALATWGVHEEQRARGLAYIQDNLWRLGEDDEEWMMVGFEITFPVLLEKAKNLGLDINYDDPALQDIYAKRQLKLAKIPREALHARPTTLLHSLEGMENLDWERLLQFKCPAGSLHSSPAASAYALSETGDKELLEYLETAINNFDGGAPCTYPVDNFDRLWSVDRLRRLGISRYFTSEIEEYLEYAYRHLSPDGMSYGGLCPVKDIDDTAMAFRLLRLHGYNVSSSVFNHFEKDGEYFCFAGQSSQSLTAMYNSYRASQIVFPGDDDGLEQLRAYCRAFLEERRATGNLRDKWVIANGLPSEVEYALDFPWKASLPRVETRVYLEQYGASEDAWIGKGLYRMTLVNNDLYLEAAKADFTNFQRLSRLEWLSLKRWYIRNNLQAHGVTEQSVLRAYFLAAANIFEPNRAAERLGWARTAILAEAIASHLRQYSANGAADGMTERLISGLASHDWDWRESNDSAARSLLYALDELIDLHAFGNASDSLREAWKQWLMSWTNESQGSTGGDTALLLVRTIEICSGRHGSAEQSLKNSEDYARLEQIASSMCSKLATKILAQNGGSMDNVEGIDQEVDVEMKELIQRVYGSSSNDVSSVTRQTFLDVVKSFCYVAHCSPETIDGHISKVLFEDVN

SEQ ID NO: 5 - protein, 757 aa, Saccharomyces cerevisiae
MKREQYTILNEKESMAEELILRIKRMFSEIENTQTSASAYDTAWVAMVPSLDSSQQPQFPQCLSWIIDNQLLDGSWGIPYLIIKDRLCHTLACVIALRKWNAGNQNVETGLRFLRENIEGIVHEDEYTPIGFQIIFPAMLEEARGLGLELPYDLTPIKLMLTHREKIMKGKAIDHMHEYDSSLIYTVEGIHKIVDWNKVLKHQNKDGSLFNSPSATACALMHTRKSNCLEYLSSMLQKLGNGVPSVYPINLYARISMIDRLQRLGLARHFRNEIIHALDDIYRYWMQRETSREGKSLTPDIVSTSIAFMLLRLHGYDVPADVFCCYDLHSIEQSGEAVTAMLSLYRASQIMFPGETILEEIKTVSRKYLDKRKENGGIYDHNIVMKDLRGEVEYALSVPWYASLERIENRRYIDQYGVNDTWIAKTSYKIPCISNDLFLALAKQDYNICQAIQQKELRELERWFADNKFSHLNFARQKLIYCYFSAAATLFSPELSAARVVWAKNGVITTVVDDFFDVGGSSEEIHSFVEAVRVWDEAATDGLSENVQILFSALYNTVDEIVQQAFVFQGRDISIHLREIWYRLVNSMMTEAQWARTHCLPSMHEYMENAEPSIALEPIVLSSLYFVGPKLSEEIICHPEYYNLMHLLNICGRLLNDIQGCKREAHQGKLNSVTLYMEENSGTTMEDAIVYLRKTIDESRQLLLKEVLRPSIVPRECKQLHWNMMRILQLFYLKNDGFTSPTEMLGYVNAVIVDPIL

SEQ ID NO: 6 - protein, 499 aa, Saccharomyces cerevisiae
MDTLTLSLGFLSLFLFLFLLKRSTHKHSKLSHVPVVPGLPVIGNLLQLKEKKPHKTFTKMAQKYGPIFSIKAGSSKIIVLNTAHLAKEAMVTRYSSISKRKLSTALTILTSDKCMVAMSDYNDFHKMVKKHILASVLGANAQKRLRFHREVMMENMSSKFNEHVKTLSDSAVDFRKIFVSELFGLALKQALGSDIESIYVEGLTATLSREDLYNTLVVDFMEGAIEVDWRDFFPYLKWIPNKSFEKKIRRVDRQRKIIMKALINEQKKRLTSGKELDCYYDYLVSEAKEVTEEQMIMLLWEPIIETSDTTLVTTEWAMYELAKDKNRQDRLYEELLNVCGHEKVTDEELSKLPYLGAVFHETLRKHSPVPIVPLRYVDEDTELGGYHIPAGSEIAINIYGCNMDSNLWENPDQWIPERFLDEKYAQADLYKTMAFGGGKRVCAGSLQAMLIACTAIGRLVQEFEWELGHGEEENVDTMGLTTHRLHPLQVKLKPRNRIY

SEQ ID NO: 7 - protein, 711 aa, Saccharomyces cerevisiae
MSSSSSSSTSMIDLMAAIIKGEPVIVSDPANASAYESVAAELSSMLIENRQFAMIVTTSIAVLIGCIVMLVWRRSGSGNSKRVEPLKPLVIKPREEEIDDGRKKVTIFFGTQTGTAEGFAKALGEEAKARYEKTRFKIVDLDDYAADDDEYEEKLKKEDVAFFFLATYGDGEPTDNAARFYKWFTEGNDRGEWLKNLKYGVFGLGNRQYEHFNKVAKVVDDILVEQGAQRLVQVGLGDDDQCIEDDFTAWREALWPELDTILREEGDTAVATPYTAAVLEYRVSIHDSEDAKFNDINMANGNGYTVFDAQHPYKANVAVKRELHTPESDRSCIHLEFDIAGSGLTYETGDHVGVLCDNLSETVDEALRLLDMSPDTYFSLHAEKEDGTPISSSLPPPFPPCNLRTALTRYACLLSSPKKSALVALAAHASDPTEAERLKHLASPAGKDEYSKWVVESQRSLLEVMAEFPSAKPPLGVFFAGVAPRLQPRFYSISSSPKIAETRIHVTCALVYEKMPTGRIHKGVCSTWMKNAVPYEKSENCSSAPIFVRQSNFKLPSDSKVPIIMIGPGTGLAPFRGFLQERLALVESGVELGPSVLFFGCRNRRMDFIYEEELQRFVESGALAELSVAFSREGPTKEYVQHKMMDKASDIWNMISQGAYLYVCGDAKGMARDVHRSLHTIAQEQGSMDSTKAEGFVKNLQTSGRYLRDVW

SEQ ID NO: 8 - protein, 481 aa, Saccharomyces cerevisiae
MDAMATTEKKPHVIFIPFPAQSHIKAMLKLAQLLHHKGLQITFVNTDFIHNQFLESSGPHCLDGAPGFRFETIPDGVSHSPEASIPIRESLLRSIETNFLDRFIDLVTKLPDPPTCIISDGFLSVFTIDAAKKLGIPVMMYWTLAACGFMGFYHIHSLIEKGFAPLKDASYLTNGYLDTVIDWVPGMEGIRLKDFPLDWSTDLNDKVLMFTTEAPQRSHKVSHHIFHTFDELEPSIIKTLSLRYNHIYTIGPLQLLLDQIPEEKKQTGITSLHGYSLVKEEPECFQWLQSKEPNSVVYVNFGSTTVMSLEDMTEFGWGLANSNHYFLWIIRSNLVIGENAVLPPELEEHIKKRGFIASWCSQEKVLKHPSVGGFLTHCGWGSTIESLSAGVPMICWPYSWDQLTNCRYICKEWEVGLEMGTKVKRDEVKRLVQELMGEGGHKMRNKAKDWKEKARIAIAPNGSSSLNIDKMVKEITVLARN

SEQ ID NO: 9 - protein, 460 aa, Saccharomyces cerevisiae
MAEQQKIKKSPHVLLIPFPLQGHINPFIQFGKRLISKGVKTTLVTTIHTLNSTLNHSNTTTTSIEIQAISDGCDEGGFMSAGESYLETFKQVGSKSLADLIKKLQSEGTTIDAIIYDSMTEWVLDVAIEFGIDGGSFFTQACVVNSLYYHVHKGLISLPLGETVSVPGFPVLQRWETPLILQNHEQIQSPWSQMLFGQFANIDQARWVFTNSFYKLEEEVIEWTRKIWNLKVIGPTLPSMYLDKRLDDDKDNGFNLYKANHHECMNWLDDKPKESVVYVAFGSLVKHGPEQVEEITRALIDSDVNFLWVIKHKEEGKLPENLSEVIKTGKGLIVAWCKQLDVLAHESVGCFVTHCGFNSTLEAISLGVPVVAMPQFSDQTTNAKLLDEILGVGVRVKADENGIVRRGNLASCIKMIMEEERGVIIRKNAVKWKDLAKVAVHEGGSSDNDIVEFVSELIKA

SEQ ID NO: 10 - protein, 485 aa, Saccharomyces cerevisiae
MYNVTYHQNSKAMATSDSIVDDRKQLHVATFPWLAFGHILPYLQLSKLIAEKGHKVSFLSTTRNIQRLSSHISPLINVVQLTLPRVQELPEDAEATTDVHPEDIPYLKKASDGLQPEVTRFLEQHSPDWIIYDYTHYWLPSIAASLGISRAHFSVTTPWAIAYMGPSADAMINGSDGRTTVEDLTTPPKWFPFPTKVCWRKHDLARLVPYKAPGISDGYRMGLVLKGSDCLLSKCYHEFGTQWLPLLETLHQVPVVPVGLLPPEIPGDEKDETWVSIKKWLDGKQKGSVVYVALGSEVLVSQTEVVELALGLELSGLPFVWAYRKPKGPAKSDSVELPDGFVERTRDRGLVWTSWAPQLRILSHESVCGFLTHCGSGSIVEGLMFGHPLIMLPIFGDQPLNARLLEDKQVGIEIPRNEEDGCLTKESVARSLRSVVVEKEGEIYKANARELSKIYNDTKVEKEYVSQFVDYLEKNARAVAIDHES

SEQ ID NO: 11 - protein, 458 aa, Saccharomyces cerevisiae
MENKTETTVRRRRRIILFPVPFQGHINPILQLANVLYSKGFSITIFHTNFNKPKTSNYPHFTFRFILDNDPQDERISNLPTHGPLAGMRIPIINEHGADELRRELELLMLASEEDEEVSCLITDALWYFAQSVADSLNLRRLVLMTSSLFNFHAHVSLPQFDELGYLDPDDKTRLEEQASGFPMLKVKDIKSAYSNWQILKEILGKMIKQTKASSGVIWNSFKELEESELETVIREIPAPSFLIPLPKHLTASSSSLLDHDRTVFQWLDQQPPSSVLYVSFGSTSEVDEKDFLEIARGLVDSKQSFLWVVRPGFVKGSTWVEPLPDGFLGERGRIVKWVPQQEVLAHGAIGAFWTHSGWNSTLESVCEGVPMIFSDFGLDQPLNARYMSDVLKVGVYLENGWERGEIANAIRRVMVDEEGEYIRQNARVLKQKADVSLMKGGSSYESLESLVSYISSL

SEQ ID NO: 12 - protein, 436 aa, Saccharomyces cerevisiae
MDASDSSPLHIVIFPWLAFGHMLASLELAERLAARGHRVSFVSTPRNISRLRPVPPALAPLIDFVALPLPRVDGLPDGAEATSDIPPGKTELHLKALDGLAAPFAAFLDAACADGSTNKVDWLFLDNFQYWAAAAAADHKIPCALNLTFAASTSAEYGVPRVEPPVDGSTASILQRFVLTLEKCQFVIQRACFELEPEPLPLLSDIFGKPVIPYGLVPPCPPAEGHKREHGNAALSWLDKQQPESVLFIALGSEPPVTVEQLHEIALGLELAGTTFLWALKKPNGLLLEADGDILPPGFEERTRDRGLVAMGWVPQPIILAHSSVGAFLTHGGWASTIEGVMSGHPMLFLTFLDEQRINAQLIERKKAGLRVPRREKDGSYDRQGIAGAIRAVMCEEESKSVFAANAKKMQEIVSDRNCQEKYIDELIQRLGSFEK

SEQ ID NO: 13 - protein, 523 aa, Saccharomyces cerevisiae
MEVTVASSVALSLVFISIVVRWAWSVVNWVWFKPKKLERFLREQGLKGNSYRFLYGDMKENSILLKQARSKPMNLSTSHDIAPQVTPFVDQTVKAYGKNSFNWVGPIPRVNIMNPEDLKDVLTKNVDFVKPISNPLIKLLATGIAIYEGEKWTKHRRIINPTFHSERLKRMLPSFHQSCNEMVKEWESLVSKEGSSCELDVWPFLENMSADVISRTAFGTSYKKGQKIFELLREQVIYVTKGFQSFYIPGWRFLPTKMNKRMNEINEEIKGLIRGIIIDREQIIKAGEETNDDLLGALMESNLKDIREHGKNNKNVGMSIEDVIQECKLFYFAGQETTSVLLAWTMVLLGQNQNWQDRARQEVLQVFGSSKPDFDGLAHLKVVTMILLEVLRLYPPVIELIRTIHKKTQLGKLSLPEGVEVRLPTLLIHHDKELWGDDANQFNPERFSEGVSKATKNRLSFFPFGAGPRICIGQNFSMMEAKLALALILQHFTFELSPSHAHAPSHRITLQPQYGVRIILHRR

SEQ ID NO: 14 - protein, 525 aa, Saccharomyces cerevisiae
MESLVVHTVNAIWCIVIVGIFSVGYHVYGRAVVEQWRMRRSLKLQGVKGPPPSIFNGNVSEMQRIQSEAKHCSGDNIISHDYSSSLFPHFDHWRKQYGRIYTYSTGLKQHLYINHPEMVKELSQTNTLNLGRITHITKRLNPILGNGIITSNGPHWAHQRRIIAYEFTHDKIKGMVGLMVESAMPMLNKWEEMVKRGGEMGCDIRVDEDLKDVSADVIAKACFGSSFSKGKAIFSMIRDLLTAITKRSVLFRFNGFTDMVFGSKKHGDVDIDALEMELESSIWETVKEREIECKDTHKKDLMQLILEGAMRSCDGNLWDKSAYRRFVVDNCKSIYFAGHDSTAVSVSWCLMLLALNPSWQVKIRDEILSSCKNGIPDAESIPNLKTVTMVIQETMRLYPPAPIVGREASKDIRLGDLVVPKGVCIWTLIPALHRDPEIWGPDANDFKPERFSEGISKACKYPQSYIPFGLGPRTCVGKNFGMMEVKVLVSLIVSKFSFTLSPTYQHSPSHKLLVEPQHGVVIRVV

SEQ ID NO: 15 - protein, 500 aa, Saccharomyces cerevisiae
MEASYLYISILLLLASYLFTTQLRRKSANLPPTVFPSIPIIGHLYLLKKPLYRTLAKIAAKYGPILQLQLGYRRVLVISSPSAAEECFTNNDVIFANRPKTLFGKIVGGTSLGSLSYGDQWRNLRRVASIEILSVHRLNEFHDIRVDENRLLIRKLRSSSSPVTLITVFYALTLNVIMRMISGKRYFDSGDRELEEEGKRFREILDETLLLAGASNVGDYLPILNWLGVKSLEKKLIALQKKRDDFFQGLIEQVRKSRGAKVGKGRKTMIELLLSLQESEPEYYTDAMIRSFVLGLLAAGSDTSAGTMEWAMSLLVNHPHVLKKAQAEIDRVIGNNRLIDESDIGNIPYIGCIINETLRLYPAGPLLFPHESSADCVISGYNIPRGTMLIVNQWAIHHDPKVWDDPETFKPERFQGLEGTRDGFKLMPFGSGRRGCPGEGLAIRLLGMTLGSVIQCFDWERVGDEMVDMTEGLGVTLPKAVPLVAKCKPRSEMTNLLSEL